(19) United States
(12) Patent Application Publication
(10) Pub. No.: US 2023/0177970 A1
(43) Pub. Date: Jun. 8, 2023

(54) COOKING LEARNING ASSISTANCE SYSTEM AND COOKING LEARNING ASSISTANCE METHOD

(71) Applicant: Panasonic Intellectual Property Management Co., Ltd., Osaka (JP)

(72) Inventors: YUKI TAOKA, Kyoto (JP); YASUHIRO YUKI, Kanagawa (JP); MASAFUMI SADAHIRA, Shiga (JP); HIROKI YAMADA, Shiga (JP); SHIKI KOU, Kyoto (JP)

(21) Appl. No.: 17/998,787

(22) PCT Filed: May 12, 2021
(86) PCT No.: PCT/JP2021/018055

§ 371 Date: Nov. 14, 2022

(30) Foreign Application Priority Data
May 21, 2020 (JP) 2020-089100

(51) Int. Cl. G09B 5/02; G09B 19/00

(52) U.S. Cl. CPC G09B 5/02; G09B 19/00

(57) ABSTRACT

A cooking-learning support system includes a storage, an information presenter, and a controller. The storage stores a recipe including at least one cooking process, a cooking element that is one of an ingredient for cooking, a cooking method for the ingredient, and a combination of the ingredient and the cooking method, and a cooking-element reference level of the cooking element. The information presenter presents the recipe. The controller calculates a recipe reference level corresponding to the recipe, based on the cooking-element reference level of the cooking element corresponding to the cooking process in the recipe, and causes the information presenter to present the calculated recipe reference level along with the recipe. A cooking-learning support method is implemented in the cooking-learning support system.

### TECHNICAL FIELD

The present invention relates to a cooking-learning support system and a cooking-learning support method which are each for presenting a recipe reference level concerning a recipe.

### BACKGROUND ART

When going to cook an unfamiliar kind of dish or trying to learn a cooking method, a cook often refers to recipes. Usually, before the cook selects a recipe suitable for the cook’s cooking skill from among many recipes, the cook refers to the names of possible recipes, foodstuffs described in the recipes, and the like.

However, it is difficult for the cook to choose an appropriate recipe. If the cooler selects a kind of dish that is too difficult for the cook, the cook will not be able to cook it properly. If the cook selects a kind of dish that is too easy for the cook, the cook’s cooking skill will not be improved.

To date a cooking apparatus has been developed which proposes a recipe for the next cooking, with the difficulty degree of cooking being assigned to the recipe. Patent Literature 1 discloses a heating cooker that stores the difficulty degree of each of a plurality of cooking menus and that selects and displays a recommended menu based on the difficulty degree of the cooking menu that has been implemented.

Unfortunately, in the conventional heating cooker described above, it has been difficult to assign appropriate difficulty degrees to various kinds of recipes. With the above-mentioned prior art, a cook is provided with no information regarding the basis for what is used as a reference to the assignment of the difficulty degree to the recipe and the basis for what is used as a reference to the proposal of the recipe.

Therefore, it is difficult to select a recipe that is reasonable or appropriate for the cook. In cases where a plurality of cooks works together, it is more difficult to determine a reference to the difficulty degree of a recipe and to propose an appropriate recipe.

### Citation List

### Patent Literature

PTL 1: Japanese Patent Unexamined Publication No. 2015-155767

### SUMMARY OF THE INVENTION

An object of the present disclosure is to provide a support system and a support method which are intended to properly calculate a recipe reference level of a recipe and to present the result to a cook.

An aspect of the present disclosure is a cooking-learning support system that includes a storage, an information presenter, and a controller.

The storage stores a recipe including at least one cooking process, a cooking element that is one of an ingredient for cooking, a cooking method for the ingredient, and a combination of the ingredient and the cooking method, and a cooking-element reference level of the cooking element. The information presenter presents the recipe. The controller calculates a recipe reference level corresponding to the recipe, based on the cooking-element reference level of the cooking element corresponding to the cooking process in the recipe, and causes the information presenter to present the calculated recipe reference level along with the recipe.

Another aspect of the present disclosure is a cooking-learning support method that includes the steps of reading, calculating, and presenting.

In the step of reading, there are read a recipe including at least one cooking process, and a cooking-element reference level of a cooking element corresponding to the cooking process in the recipe. The cooking element is one of an ingredient for cooking, a cooking method for the ingredient, and a combination of the ingredient and the cooking method.

In the step of calculating, a recipe reference level corresponding to the recipe is calculated based on the cooking-element reference level corresponding to the cooking element in the cooking process in the recipe. In the step of presenting, the calculated recipe reference level is presented along with the recipe.

With the cooking-learning support system and the cooking-learning support method, both according to the present disclosure, when recipes are presented, the recipe reference levels based on the cooking elements included in the recipes are presented. This allows a cook to easily select a recipe.

### BRIEF DESCRIPTION OF DRAWINGS

FIG. 1A is a block diagram showing a schematic configuration of a cooking-learning support system.

FIG. 1B is a block diagram showing a more detailed schematic configuration of the cooking-learning support system.

FIG. 2 is a table showing cooking elements.

FIG. 3 is a table showing cooking elements corresponding to cooking processes.

FIG. 4A is a diagram showing presented recipes and presented recipe reference levels.

FIG. 4B is a diagram showing presented recipes and presented recipe reference levels.

FIG. 5 is a flowchart illustrating a cooking-learning support method.

FIG. 6A is a table showing cooking elements that are ingredients only, and showing the cooking element-difficulty degrees of the cooking elements.

FIG. 6B is a table showing cooking elements that are cooking methods only, and showing the cooking element-difficulty degrees of the cooking methods.

FIG. 6C is a table showing cooking elements that include combinations of ingredients and cooking methods, and showing the cooking element-difficulty degrees of the cooking elements.

FIG. 6D is a table showing cooking elements that include ingredients, cooking methods, and combinations of ingredients and cooking methods, and showing the cooking element-difficulty degrees of the cooking elements.

FIG. 7A is a chart showing the recipe-difficulty degrees that are presented using a radar chart.

FIG. 7B is a graph showing the recipe-difficulty degrees that are presented using a vertical bar graph.

FIG. 8 is a chart showing the recipe-difficulty degrees that are presented in terms of items other than the cooking element-difficulty degree.

FIG. 9A is a diagram showing a recipe and a recipe-difficulty degree which are presented in multiple grades.

FIG. 9B is a diagram showing a recipe and a recipe-difficulty degree which are presented in multiple grades.

FIG. 10A is a diagram showing supplementary information that is presented along with recipes and recipe-difficulty degrees.

FIG. 10B is a diagram showing supplementary information that is presented along with recipes and recipe-difficulty degrees.

FIG. 11 is a diagram showing a recipe group containing a plurality of recipes each of which has a different recipe-difficulty degree.

FIG. 12A is a diagram showing visual presentation of learning levels.

FIG. 12B is a diagram showing visual presentation of learning levels.

FIG. 13 is a chart showing learning levels that are presented along with recipes and recipe-difficulty degrees thereof.

FIG. 14 is a diagram showing learning levels that are common among a plurality of recipes.

FIG. 15A is a chart showing the recipe-difficulty degrees presented in a radar chart, for each cooking date and number of cooking times.

FIG. 15B is a chart showing the recipe-difficulty degrees presented in a horizontal bar graph, for each cooking date and number of cooking times.

FIG. 16A is a diagram showing one example of a user interface for use in inputting a learning level-setting command.

FIG. 16B is a diagram showing another example of the user interface for use in inputting a learning level-setting command.

FIG. 17 is a diagram showing a presentation of a proposed recipe.

FIG. 18A is a table showing the cooking element-participation degrees of cooking elements.

FIG. 18B is a table showing the cooking element-participation degrees of cooking elements.

FIG. 19 is a table showing cooking elements participable for each age.

FIG. 20 is a diagram showing presented recipes and their recipe-participation degrees.

FIG. 21 is a diagram showing cooking processes presented in a format emphasizing a cooking process participable by a second cook.

FIG. 22 is a table showing support information.

FIG. 23 is a diagram showing a presentation of support information.

FIG. 24 is a table showing alternative cooking methods.

FIG. 25 is a diagram showing cooking elements and cooking processes which all have been changed using alternative cooking methods.

FIG. 26 is a diagram showing presentation of cooking processes and their support information which have been changed using alternative cooking methods.

FIG. 27 is a diagram showing presentation of an age corresponding to support information.

FIG. 28 is a diagram showing cooking elements participable by specific second cooks.

FIG. 29A is a diagram showing the recipes and recipe-participation degrees thereof which are presented for a specific second cook.

FIG. 29B is a diagram showing the recipes and recipe-participation degrees thereof which are presented for specific second cooks.

FIG. 29C is a diagram showing the recipes and recipe-participation degrees thereof which are presented for specific second cooks.

FIG. 30 is a diagram showing one example of a user interface for inputting a unique participation degree-setting command.

FIG. 31 is a diagram showing the presentation of names of specific second cooks, with the manes corresponding to respective support information for the specific second cooks.

### DESCRIPTION OF EMBODIMENTS

A first aspect of the present disclosure is a cooking-learning support system that includes a storage, an information presenter, and a controller.

The storage stores at least one recipe including at least one cooking process, at least one cooking element that is one of at least one ingredient for cooking, at least one cooking method for the at least one ingredient, and a combination of the at least one ingredient and the at least one cooking method, and a cooking-element reference level of the cooking element.

The information presenter presents the at least one recipe.

The controller calculates a recipe reference level corresponding to the recipe based on the cooking-element reference level of the at least one cooking element that corresponds to the at least one cooking process in the at least one recipe, and causes the information presenter to present the thus-calculated recipe reference level along with the at least one recipe.

In the cooking-learning support system according to a second aspect of the present disclosure, in addition to the first aspect, the cooking-element reference level is at least one cooking element-difficulty degree of the at least one cooking element, and the recipe reference level is a recipe-difficulty degree of the at least one recipe.

In the cooking-learning support system according to a third aspect of the present disclosure, in addition to the second aspect, the controller sets the at least one cooking element in the at least one recipe as an item of a chart, and causes the information presenter to present the recipe-difficulty degree in the chart by causing the information presenter to present the at least one cooking element-difficulty degree corresponding to each being the item.

In the cooking-learning support system according to a fourth aspect of the present disclosure, in addition to the third aspect, the controller sets, as the item of the chart, one of a number of characters written in the at least one recipe, a number of the cooking processes in the at least one recipe, a number of the ingredients for use in the at least one recipe, and required cooking time in the at least one recipe.

In the cooking-learning support system according to a fifth aspect of the present disclosure, in addition to any one of the second to fourth aspects, the controller classifies the recipe-difficulty degree into a plurality of difficulty-degree classes by using at least one difficulty-degree classification threshold value, and causes the information presenter to present the plurality of difficulty-degree classes along with both the at least one recipe and the recipe-difficulty degree.

In the cooking-learning support system according to a sixth aspect of the present disclosure, in addition to any one of the second to fifth aspects, the cooking element-difficulty degrees of the cooking elements correspond to the cooking processes in the at least one recipe, and the controller calculates one of a sum total of the cooking element-difficulty degrees, a maximum value of the cooking element-difficulty degrees, and an average value of the cooking element-difficulty degrees, and sets the one of the sum total, the maximum value, and the average value as the at least one recipe-difficulty degree corresponding to the at least one recipe.

In the cooking-learning support system according to a seventh aspect of the present disclosure, in addition to any one of the second to sixth aspects, the storage stores supplementary information corresponding to the at least one recipe, the supplementary information being information that relates to either the at least one ingredient in the at least one recipe or the at least one cooking method and that relates to the recipe-difficulty degree of the at least one recipe.

For a presented recipe being the at least one recipe having the recipe-difficulty degree that is either not lower than a first difficulty-degree threshold value or not higher than a second difficulty-degree threshold value lower than the first difficulty-degree threshold value, the controller causes the information presenter to present the supplementary information along with both the presented recipe and the recipe-difficulty degree.

In the cooking-learning support system according to an eighth aspect of the present disclosure, in addition to the seventh aspect, in the case where the recipe-difficulty degree of the presented recipe is not lower than the first difficulty-degree threshold value, the supplementary information indicates that the presented recipe includes the at least one cooking process corresponding to the at least one cooking element-difficulty degree not lower than a third difficulty-degree threshold value, and in the case where the recipe-difficulty degree of the presented recipe is not higher than the second difficulty-degree threshold value, the supplementary information indicates that the presented recipe does not include the at least one cooking process corresponding to the at least one cooking element-difficulty degree not higher than a fourth difficulty-degree threshold value.

In the cooking-learning support system according to a ninth aspect of the present disclosure, in addition to the seventh aspect, the storage stores a recipe group including the at least one recipe, the presented recipe being included in the recipe group, in which, in the case where the recipe-difficulty degree of the presented recipe is not higher than the second difficulty-degree threshold value, the supplementary information indicates either that the presented recipe does not include a designated ingredient included in a predetermined number of other recipes included in the recipe group, or that the presented recipe includes one of a substitute cooking method and a substitute ingredient.

In the cooking-learning support system according to a tenth aspect of the present disclosure, in addition to any one of the second to ninth aspects, the storage stores a learning level of the first cook for the at least one cooking element, and the controller causes the information presenter to present the learning level along with both a presented recipe and the recipe-difficulty degree.

In the cooking-learning support system according to an eleventh aspect of the present disclosure, in addition to the tenth aspect, the storage stores the learning level for each either a cooking date or a number of cooking times, and the controller causes the information presenter to present the learning level for each either the cooking date or the number of cooking times.

In the cooking-learning support system according to a twelfth aspect of the present disclosure, in addition to the tenth aspect, the learning level for the at least one cooking element is settable either manually or automatically.

The cooking-learning support system according to a thirteenth aspect of the present disclosure, in addition to the twelfth aspect, further includes an input part, the controller receiving a learning level-setting command for setting a learning level for at least one cooking element via the input part, in which, when the controller receives the learning level-setting command, the controller sets the learning level for the at least one cooking element in accordance with the learning level-setting command.

In the cooking-learning support system according to a fourteenth aspect of the present disclosure, in addition to the twelfth or thirteenth aspect, when a cooking record of the at least one cooking element becomes not smaller than a predetermined number of times, the controller raises the learning level for the at least one cooking element.

In the cooking-learning support system according to a fifteenth aspect of the present disclosure, in addition to any one of the tenth to fourteenth aspects, the storage stores a plurality of recipes, each recipe identical to the at least one recipe, and the controller causes the information presenter to present a recipe of the plurality of recipes as a proposed recipe, the presented recipe including at least one cooking element having a cooking element-difficulty degree higher than the learning level by a predetermined degree.

In the cooking-learning support system according to a sixteenth aspect of the present disclosure, in addition to the second aspect, in the case where the cooking elements in the plurality of recipes are identical, the cooking element-difficulty degree is common to the identical cooking elements.

In the cooking-learning support system according to a seventeenth aspect of the present disclosure, in addition to the tenth to fifteenth aspects, in the case where the cooking elements in the plurality of recipes are identical, the learning level is common to the identical cooking elements.

In the cooking-learning support system according to an eighteenth aspect of the present disclosure, in addition to the first aspect, the cooking-element reference level is a cooking element-participation degree that indicates an extent to which a second cook of a specific age can participate in implementation of the at least one cooking element and the at least one recipe, and the recipe reference level is a recipe-participation degree that indicates the extent to which the second cook of the specific age can participate in the implementation of the at least one cooking element and the at least one recipe.

In the cooking-learning support system according to a nineteenth aspect of the present disclosure, in addition to the eighteenth aspect, the cooking element-participation degree indicates whether or not the implementation of the at least one cooking element is participable by the second cook, and the controller calculates a ratio, to all of the at least one recipe, of the cooking process corresponding to the at least one cooking element participable by the second cook and sets the ratio as the recipe-participation degree corresponding to the recipe.

The cooking-learning support system according to a twentieth aspect of the present disclosure, in addition to the eighteenth or nineteenth aspect, further includes an input part, the controller acquiring a designated age via the input part, in which, when the controller acquires the designated age, the controller causes the information presenter to present, as a proposed recipe, a recipe having the recipe-participation degree for the designated age, the recipe-participation degree being not lower than a participation-degree threshold value.

In the cooking-learning support system according to a twenty-first aspect of the present disclosure, in addition to the twentieth aspect, the controller causes the information presenter to present recipes each having the recipe-participation degree for the designated age in a descending order of the recipe-participation degree, the recipe-participation degree being not lower than a participation-degree threshold value.

In the cooking-learning support system according to a twenty-second aspect of the present disclosure, in addition to any one of the eighteenth to twenty-first aspects, the controller causes the information presenter to present, along with the at least one recipe and the recipe-participation degree, the at least one cooking process in the at least one recipe in a format emphasizing the at least one cooking process participable by the second cook.

In the cooking-learning support system according to a twenty-third aspect of the present disclosure, in addition to any one of the eighteenth to twenty-second aspects, the storage stores either first support information for a first cook assisting the second cook or second support information for the second cook, both the first support information and the second support information corresponding to the at least one cooking element participable, and the controller causes the information presenter to present the at least one cooking process and either the first support information corresponding to at least one of the cooking processes or the second support information corresponding to at least one of the cooking processes.

In the cooking-learning support system according to a twenty-fourth aspect of the present disclosure, in addition to the twenty-third aspect, the first support information is either explanation relating to participation of the second cook to the at least one cooking process or information relating to preparation for causing the second cook to participate in the at least one cooking process.

In the cooking-learning support system according to a twenty-fifth aspect of the present disclosure, in addition to the twenty-third or twenty-fourth aspect, the second support information is information expressed by wording suitable for the second cook, the expressed information being on the at least one cooking process corresponding to the second support information.

In the cooking-learning support system according to a twenty-sixth aspect of the present disclosure, in addition to any one of the twenty-third to twenty-fifth aspects, the storage stores at least one of the cooking methods as a designated cooking method, and stores an alternative cooking method to the designated cooking method for each of the specific ages, in which, in the at least one cooking element including the designated cooking method, the controller is operable to cause the alternative cooking method to be presented instead of the designated cooking method, and in which either the first support information or the second support information is based on the alternative cooking method.

In the cooking-learning support system according to a twenty-seventh aspect of the present disclosure, in addition to any one of the twenty-third to twenty-sixth aspects, the controller causes the information presenter to present the following information along with the at least one cooking process and one of the first support information and the second support information.

The information indicates an age corresponding to the one of the first support information and the second support information, and is at least one of a character, a numeral, a symbol, a picture, a figure, a crest, a pattern, and a form.

In the cooking-learning support system according to a twenty-eighth aspect of the present disclosure, in addition to any one of the eighteenth to twenty-seventh aspects, in the case where the cooking elements in the plurality of recipes are identical, the cooking element-participation degree is common to the identical cooking elements.

In the cooking-learning support system according to a twenty-ninth aspect of the present disclosure, in addition to any one of the eighteenth to twenty-seventh aspects, the storage stores, as the cooking element-participation degree, a unique participation degree that indicates an extent to which a specific second cook can participate in the at least one cooking element.

In the cooking-learning support system according to a thirtieth aspect of the present disclosure, in addition to the twenty-ninth aspect, a default value of the unique participation degree is the cooking element-participation degree for an age of the specific second cook.

The cooking-learning support system according to a thirty-first aspect of the present disclosure, in addition to the twenty-ninth or thirtieth aspect, further includes an input part, the controller acquiring designation of the specific second cook via the input part, in which, when the controller acquires the designation of the specific second cook, the controller causes the information presenter to present, as a proposed recipe, a recipe having the recipe-participation degree for the specific second cook, the recipe-participation degree being not lower than a participation-degree threshold value.

The cooking-learning support system according to a thirty-second aspect of the present disclosure, in addition to any one of the twenty-ninth to thirty-first aspects, further includes an input part, the controller receiving a unique participation degree-setting command for setting a unique participation degree of at least one cooking element via the input part, in which, when the controller receives the unique participation degree-setting command, the controller sets the unique participation degree of the at least one cooking element in accordance with the unique participation degree-setting command.

In the cooking-learning support system according to a thirty-third aspect of the present disclosure, in addition to any one of the twenty-ninth to thirty-second aspects, in which the controller causes the information presenter to present the following information along with the at least one cooking process and one of first support information and second support information. The information is at least one of a character, a numeral, a symbol, a picture, a figure, a crest, a pattern, and a form, the at least one indicating either a name of the specific second cook or an age of the specific second cook.

In the cooking-learning support system according to a thirty-fourth aspect of the present disclosure, in addition to any one of the twenty-ninth to thirty-third aspects, in the case where the cooking elements in the plurality of recipes are identical, the unique participation degree is common to the identical cooking elements.

A thirty-fifth aspect of the present disclosure is a cooking-learning support method including the steps of reading, calculating, and presenting.

In the step of reading, there are read at least one recipe including at least one cooking process and a cooking-element reference level of at least one cooking element corresponding to the at least one cooking process in the at least one recipe. In the step of reading, the at least one cooking element is one of at least one ingredient for cooking, at least one cooking method for the at least one ingredient, and a combination of the at least one ingredient and the at least one cooking method.

In the step of calculating, there is calculated a recipe reference level corresponding to the at least one recipe, based on the cooking-element reference level corresponding to the at least one cooking element in the at least one cooking process in the at least one recipe. In the step of presenting, there is presented the calculated recipe reference level along with the recipe.

In the cooking-learning support method according to a thirty-sixth aspect of the present disclosure, in addition to the thirty-fifth aspect, the cooking-element reference level is at least one cooking element-difficulty degree for a first cook, and the recipe reference level is a recipe-difficulty degree of the at least one recipe.

In the step of calculating the recipe reference level, the cooking element-difficulty degrees correspond to the cooking elements in the cooking processes in the at least one recipe, there is calculated one of a sum total of the cooking element-difficulty degrees, a maximum value of the cooking element-difficulty degrees, and an average value of the cooking element-difficulty degrees, and there is set the one of the sum total, the maximum value, and the average value, as the recipe-difficulty degree corresponding to the at least one recipe.

In the cooking-learning support method according to a thirty-seventh aspect of the present disclosure, in addition to the thirty-fifth aspect, the cooking-element reference level is a cooking element-participation degree that indicates an extent to which a second cook of a specific age can participate in implementation of the at least one cooking element and the at least one recipe, and the recipe reference level is a recipe-participation degree that indicates the extent to which the second cook of the specific age can participate in the implementation of the at least one cooking element and the at least one recipe.

The cooking element-participation degree indicates whether or not the implementation of the at least one cooking element is participable by the second cook. In the step of calculating the recipe reference level, there is calculated a ratio, to all of the at least one recipe, of the at least one cooking process corresponding to the at least one cooking element participable by the second cook, and there is set the ratio as the recipe-participation degree corresponding to the at least one recipe.

It should be noted, however, that the exemplary embodiments described hereinafter all illustrate specific examples of the present disclosure. Features such as numerical values, shapes, constitutions, contents of steps, and the order of the steps all indicated in the exemplary embodiments are merely specific examples, and are not intended to limit the present disclosure.

### First Exemplary Embodiment

Hereinafter, cooking-learning support system 10 and a cooking-learning support method, both according to the present disclosure, will be described with reference to the drawings. The cooking-learning support system according to the present disclosure executes the cooking-learning support method according to the present disclosure.

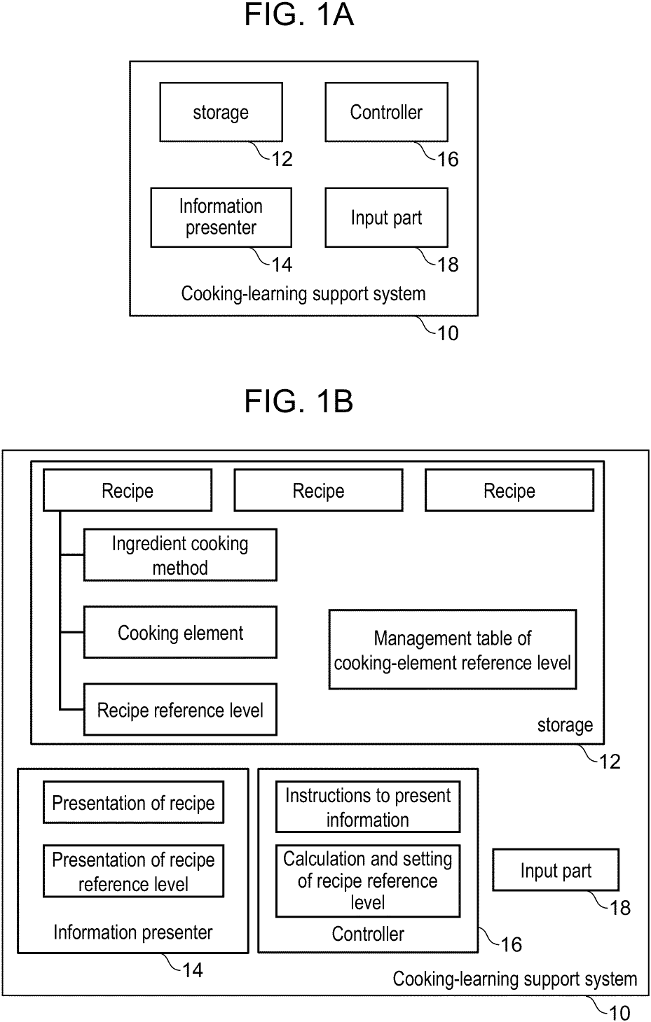

FIG. 1A is a block diagram showing a schematic configuration of cooking-learning support system 10. As shown in FIG. 1A, cooking-learning support system 10 includes storage 12, information presenter 14, controller 16, and input part 18.

Cooking-learning support system 10 is used by at least one cook. Cooking-learning support system 10 supports the cook in acquiring cooking skills by presenting recipes and reference levels. Each of the reference level is information as to whether or not such a cook is able to implement the corresponding recipe. The cook in first to sixth exemplary embodiments means the first cook in seventh to fourteenth exemplary embodiments.

FIG. 1B is a block diagram showing a more detailed schematic configuration of the cooking-learning support system. As shown in FIG. 1B, storage 12 stores a plurality of recipes, an ingredient, cooking method, cooking element and recipe reference level that all relate to each of the recipes, and a management table of cooking-element reference levels.

Controller 16 gives instructions to present information, and calculates and sets a recipe reference level. Information presenter 14 presents a recipe, a recipe reference level, etc., under the control of controller 16.

### [Storage]

Storage 12 is a recording medium for recording various kinds of information. Storage 12 is, for example, a flash memory, an SSD (solid state device), a hard disk or other storage device, or a combination thereof as appropriate.

Storage 12 stores (1) recipes each having at least one cooking process, (2) cooking elements being each one of “ingredients” for cooking, “a cooking method” for the ingredients, and “a combination of an ingredient and a cooking method,” (3) cooking-element reference levels of the cooking elements. These pieces of information are stored in the form of a database or individual files.

### [Information Presenter]

Information presenter 14 presents various kinds of information such as images and characters. Information presenter 14 is composed of a liquid crystal display, an organic EL display, a speaker, a speaker microphone, a speakerphone, and the like. Information presenter 14 includes both or one of a graphical user interface (GUI) and a voice user interface (VUI).

Information presenter 14 displays images and characters, and generates voices corresponding to the characters. Information presenter 14 may present a recipe and a recipe reference level to be described later. Information presenter 14 may present, as will be described later, a cooking process in the recipe, supplementary information regarding the recipe reference level, support information regarding the cooking process, and the like.

### [Controller]

Controller 16 controls the whole of cooking-learning support system 10. Controller 16 includes a general-purpose processor such as a CPU (central processing unit) or an MPU (micro-processing unit). Controller 16 controls cooking-learning support system 10 by calling and executing a control program stored in storage 12.

Controller 16 may be a hardware circuit exclusively for use in implementing predetermined functions. That is, controller 16 may be composed of various processors including a CPU, an MPU, a GPU (graphics processing unit), an FPGA (field programmable gate array), a DSP (digital signal processor), and an ASIC (application specific integrated circuit).

Controller 16 reads data from storage 12 and causes the storage to store data. Controller 16 causes information presenter 14 to present either the read data as they are or the data after the read data having been processed. Controller 16 controls cooking-learning support system 10 according to the cooking-learning support method to be described later, thereby calculating a recipe reference level and causing information presenter 14 to present the recipe reference level along with the recipe.

Cooking-learning support system 10 is in conformity with standards such as Wi-Fi (registered trademark), IEEE 802.2, IEEE 802.3, 3G, and LTE (long term evolution), and communicates with information terminal devices, appliances such as household electric appliances, and various servers, via various communication paths.

Such various communication paths include the Internet, an intranet, an extranet, a LAN (local area network), an ISDN (integrated services digital network), a VAN (valueadded network), a cable television communication network, a virtual private network, a telephone line network, a mobile communication network, and a satellite communication network.

### [Input Part]

Input part 18 is an input interface for receiving commands from a cook, and includes a mouse, keyboard, touch panel, touch pad, switch, and button. Input part 18 converts the commands and manipulations from the cook into electrical signals and transmits them to controller 16.

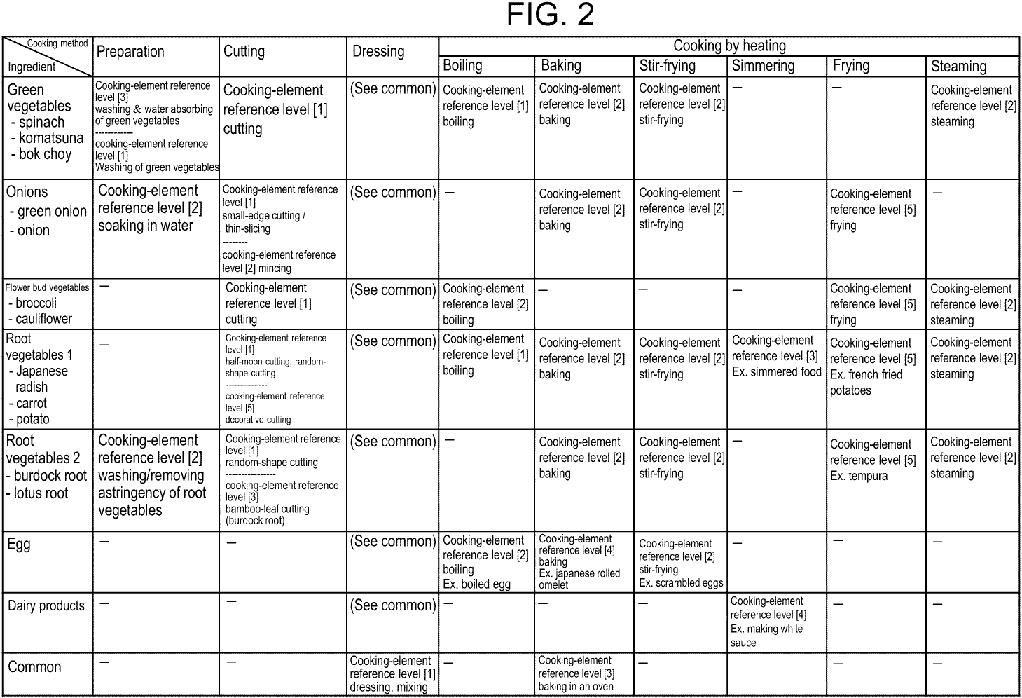

Next, terms used in the first exemplary embodiment such as the ingredient, cooking method, cooking element, cooking-element reference level, and recipe reference level will be described. FIG. 2 shows cooking elements.

As shown in FIG. 2, the ingredients include meat, fish, egg, green vegetables, root vegetables, various seasonings, water, and flour. The ingredients include a raw ingredient, a processed product, and an unfinished product of a dish. The cooking method is a way of processing ingredients. The cooking method is implemented using cooking utensils such as kitchen knives and pots, and using cooking appliances such as a rice cooker and a microwave oven. The cooking method includes preparing, boiling, stir-frying, baking, frying, and steaming.

In the present disclosure, the cooking element is one that is only an ingredient, only a cooking method, or a combination of an ingredient and a cooking method. The cooking element is expressed in the form of “Ingredient x Cooking method,” such as “Green vegetables x Boiling” and “Meat x Preparing,” for example. Storage 12 stores ingredients and cooking methods, with both being associated with cooking elements.

For example, as shown in FIG. 2, the cooking-element reference level of a cooking element “Dressing” or “Mixing” is “1 (one),” and the cooking-element reference level of a cooking element “Green vegetables x Stir-frying” is “2.”

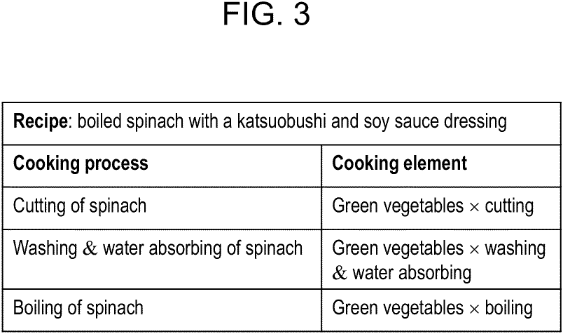

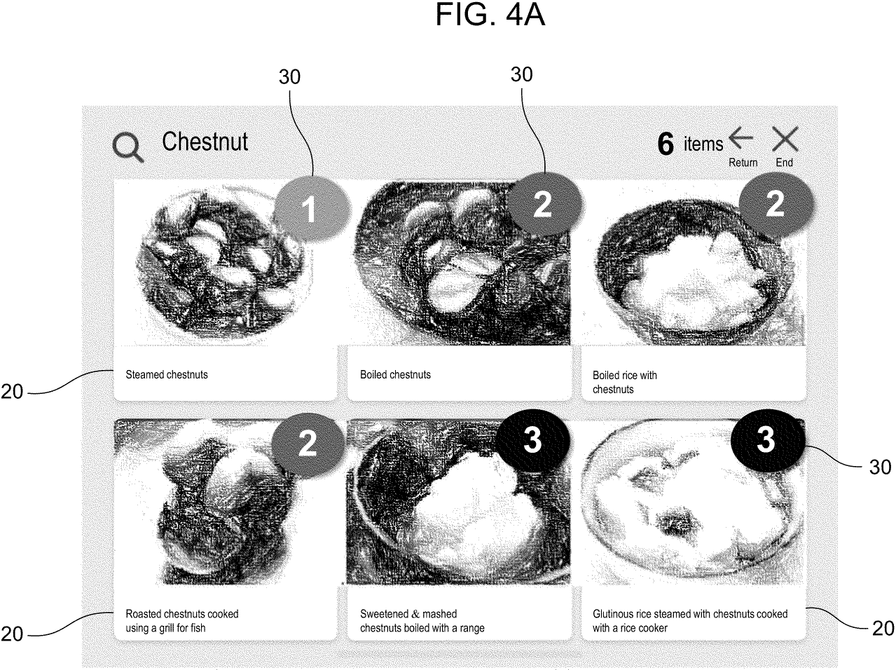

FIG. 3 shows cooking elements corresponding to cooking processes. As shown in FIG. 3, a recipe “Boiled Spinach with a Katsuobushi and Soy Sauce Dressing” includes three cooking processes. The cooking processes correspond to the respective cooking elements, that is, a cooking element “Green vegetables x Cutting,” a cooking element “Green vegetables x Washing & Water-absorbing,” and a cooking element “Green vegetables x Boiling.”

One cooking process may correspond to a plurality of cooking elements. In one cooking process in which a plurality of ingredients is processed, a typical ingredient, an ingredient requiring special care, or a superordinate concept extracted from these ingredients may be designated as the “ingredient” of the cooking element that corresponds to this one cooking process. For example, a cooking process “Add butter and onion, and stir-fry them” may correspond to a cooking element “Onions,” “Stir-frying,” or “Onions x Stir-frying.”

In a cooking process in which an ingredient is processed by a plurality of cooking methods, a typical cooking method, a cooking method requiring special care, or a superordinate concept extracted from these cooking methods may be designated as the “cooking method” of the cooking element that corresponds to the cooking process.

For example, a cooking process “Wash and cut spinach” may correspond to a cooking element “Green vegetables,” “Preparing,” or “Green vegetables x Preparing.” In the case where a recipe includes a plurality of cooking processes, each of the cooking processes may correspond to cooking elements unique to it. That is, one recipe or one cooking process may adopt a plurality of cooking elements.

A cooking element that requires relatively complicated steps is expressed by being divided into a plurality of cooking processes. For this reason, the plurality of cooking processes may correspond to one cooking element.

For example, the following plurality of cooking processes may be combined into one that corresponds to a cooking element “White sauce x Making.” Such a plurality of cooking processes is “Put flour and butter into a heat-resistant bowl, and heat them,” “Mix well, add half of the milk to be used, and heat them,” “Knead well, add the rest of the milk, and heat them further,” “Add salt and pepper, and adjust the taste,” and “Mix them well.”

A plurality of cooking processes in such a recipe may be stored as a different recipe, which allows a linkage from the recipe currently being implemented to the different recipe.

A cooking-element reference level according to the present disclosure is set for a specific cooking element. The cooking-element reference level is a reference level as to whether or not the specific cooking element is implementable by a cook when the cook implements the cooking element. For example, the cooking-element reference level may be the difficulty degree of the specific cooking element or the degree of participation indicating whether or not the cook is able to implement the cooking element.

A recipe reference level according to the present disclosure is set for a specific recipe. The recipe reference level is a reference level as to whether or not the specific recipe is implementable by a cook when the cook implements all of the specific recipe. For example, the recipe reference level may be the difficulty degree of all of the specific recipe or the degree of participation indicating how well the cook is able to implement the cooking according to the specific recipe. In the following description, carrying-out of the cooking according to a recipe is expressed as implementation of the recipe.

The recipe reference level of a specific recipe is calculated based on the cooking-element reference level of the cooking element that corresponds to the cooking process included in the specific recipe. For example, the recipe “Boiled Spinach with a Katsuobushi and Soy Sauce Dressing” shown in FIG. 3 includes three cooking processes that correspond to the respective cooking elements “Green vegetables x Cutting,” “Green vegetables x Washing & Water-absorbing,” and “Green vegetables x Boiling.”

In one example, the cooking-element reference level is any of the numerical values of 0 (zero) to 9. Controller 16 calculates the sum total, maximum value, or average value of the cooking-element reference levels of these cooking elements, and sets the thus-calculated value as the recipe reference level that corresponds to the recipe “Boiled Spinach with a Katsuobushi and Soy Sauce Dressing.” Controller 16 weights the cooking-element reference levels of the specific cooking elements “Cutting,” “Mixing,” and “Heating,” etc., before calculating a recipe-difficulty degree.

In another example, the cooking-element reference level is a numerical value of 0 (zero) or 1 (one) that indicates the feasibility of implementation of the cooking. Controller 16 calculates a ratio of the cooking processes having the cooking-element reference level of 1 (one) to the whole recipe, and sets the thus-calculated ratio as the recipe reference level that corresponds to the recipe “Boiled Spinach with a Katsuobushi and Soy Sauce Dressing.”

In one example, in the case where a plurality of recipes has the same cooking elements, their cooking-element reference levels are common. In the case where the same cooking elements are included in a plurality of recipes mutually different, the recipe reference levels of these recipes are calculated based on the common cooking-element reference level of the same cooking elements. This allows the calculation of the recipe-difficulty degree (recipe reference level) according to a consistent reference.

After having calculated the recipe reference levels, controller 16 causes information presenter 14 to present their recipe reference levels along with the recipes via a user interface. FIGS. 4A and 4B shows the thus-presented recipes and recipe reference levels. FIG. 4A presents a plurality of recipes 20 and recipe reference levels 30 of the respective recipes.

As shown in FIG. 4A, for example, the recipe reference level of the recipe “Steamed Chestnut” is “1 (one).” The recipe reference level of the recipe “Boiled Chestnut” is “2.” The recipe reference level of the recipe “Glutinous Rice Steamed with Chestnuts Cooked with a Rice Cooker” is “3.”

A cook can search for a related recipe that relates to a specific ingredient, cooking method, or recipe, via a user interface. Recipe 20 and recipe reference level 30 of recipe 20, which are the search result, are presented via a user interface.

FIG. 4A shows the search result for “Chestnut.” FIG. 4B shows a screen of application software (hereinafter, referred to as an application) which operates on an information terminal device such as a smartphone. Recipe 20 and recipe reference level 30 of recipe 20 are presented by the user interface of the application.

FIGS. 4A and 4B present a plurality of recipes 20 and recipe reference levels 30 along with images of dishes on a tile-type list screen. However, the way of presentation is not limited to this. Recipes 20 and recipe reference levels 30 may be presented by other presentation method, for example, such as a recipe list without images, a bar graph, or a radar chart.

For example, in the case of a radar chart, the whole of the presented chart is referred to as “recipe reference level 30.” Controller 16 causes information presenter 14 to visually present recipe reference level 30 by using visual elements such as a character, an image, an icon, a bar graph, and a line graph. Such a visual presentation of recipe reference level 30 allows a cook to easily grasp the characteristics of recipe 20.

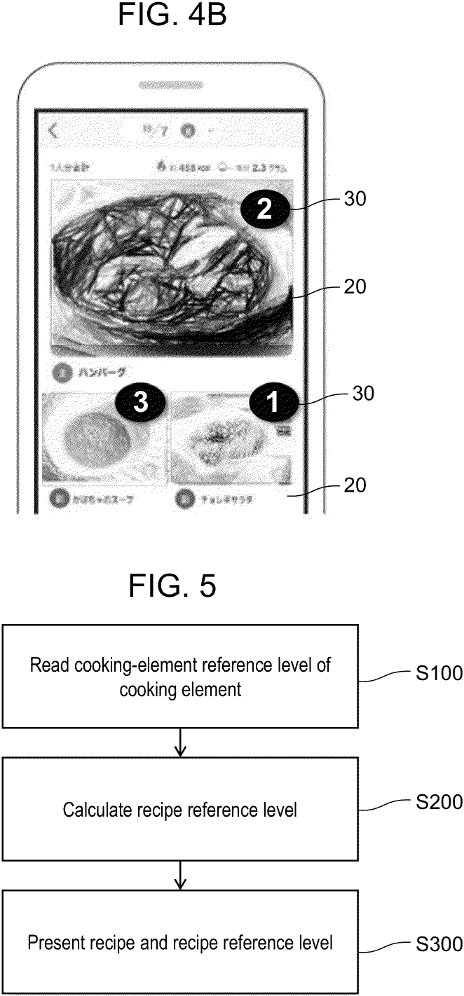

Cooking-learning support system 10 implements a cooking-learning support method. FIG. 5 is a flowchart illustrating the cooking-learning support method. As shown in FIG. 5, the cooking-learning support method includes Step S100, Step S200, and Step S300.

Controller 16 reads, from storage 12, a recipe having at least one cooking process, and a cooking-element reference level of a cooking element that corresponds to the cooking process in the recipe (Step S100).

Controller 16 calculates a recipe reference level corresponding to the recipe, based on the cooking-element reference level that corresponds to the cooking element in the cooking process in the recipe (Step S200). Controller 16 presents the thus-calculated recipe reference level along with the recipe via information presenter 14 (Step S300).

Before causing information presenter 14 to present the recipe reference level, controller 16 does not necessarily have to calculate the recipe reference level in real time (i.e., immediately). For example, when calculating the recipe reference level of a specific recipe for the first time, controller 16 may cause storage 12 to store the calculated recipe reference level.

In this case, controller 16 collates data stored on storage 12, based on the specific recipe. Controller 16 reads the recipe reference level, which has already been calculated, of the specific recipe from storage 12, thereby acquiring the recipe reference level of the specific recipe.

With the cooking-learning support system and the cooking-learning support method, the cooking-element reference level is determined for a specific ingredient, a specific cooking method, or a specific cooking element, which is a combination of an ingredient and a cooking method. For this reason, the cooking-element reference level can be determined specifically and in detail.

With the cooking-learning support system and the cooking-learning support method, the recipe reference level of the whole of a recipe is calculated based on both the cooking element included in the recipe and the cooking-element reference level of the cooking element. For this reason, the recipe reference level can be calculated appropriately and accurately.

With the cooking-learning support system and the cooking-learning support method, the recipe reference levels of recipes, along with the recipes, are presented to a cook by using a chart or the like. Therefore, the cook will select a recipe next to be implemented from among the presented recipes, after understanding the characteristics of the recipes through their recipe reference levels. Thus, the cook can select a recipe appropriate for the cook’s self.

The cooking-element reference level and the recipe reference level are common among a plurality of recipes, so that the recipe reference level has consistency. Such a recipe reference level that is calculated according to a consistent reference is highly reliable.

### Second Exemplary Embodiment

Hereinafter, a cooking-learning support system and a cooking-learning support method, both according to a second exemplary embodiment of the present disclosure, will be described with reference to the drawings. In the second embodiment, the cooking-element reference level is the cooking element-difficulty degree of a cooking element, and the recipe reference level is the recipe-difficulty degree of a recipe. The cooking element is an ingredient, a cooking method, or a combination of an ingredient and a cooking method.

The cooking element-difficulty degree is a difficulty degree regarding a specific cooking element, for example, “Dressing” or “Green vegetables x Boiling.” The cooking element-difficulty degree may be considered as the unique value of a cooking element.

The cooking element-difficulty degree is preferably not a value for a specific cook but an objective value for a general cook. The cooking element-difficulty degree is a relative value obtained by comparing a cooking element with other cooking elements and the like. The recipe-difficulty degree is a difficulty degree regarding a specific recipe. Such a difficulty degree is calculated based on the cooking element-difficulty degrees of cooking elements that correspond to the cooking processes included in the specific recipe.

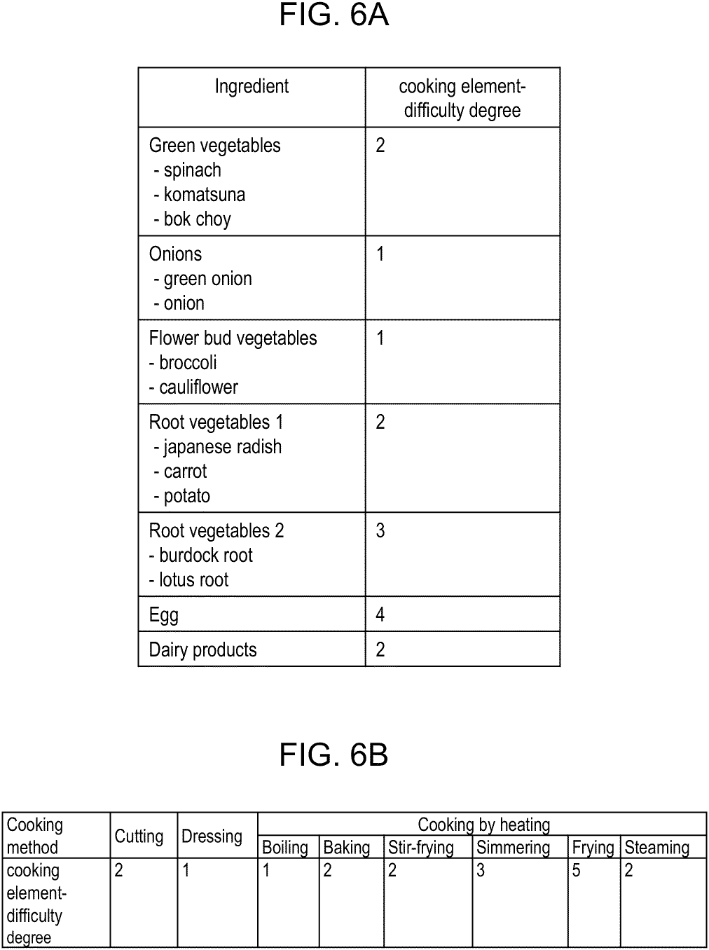

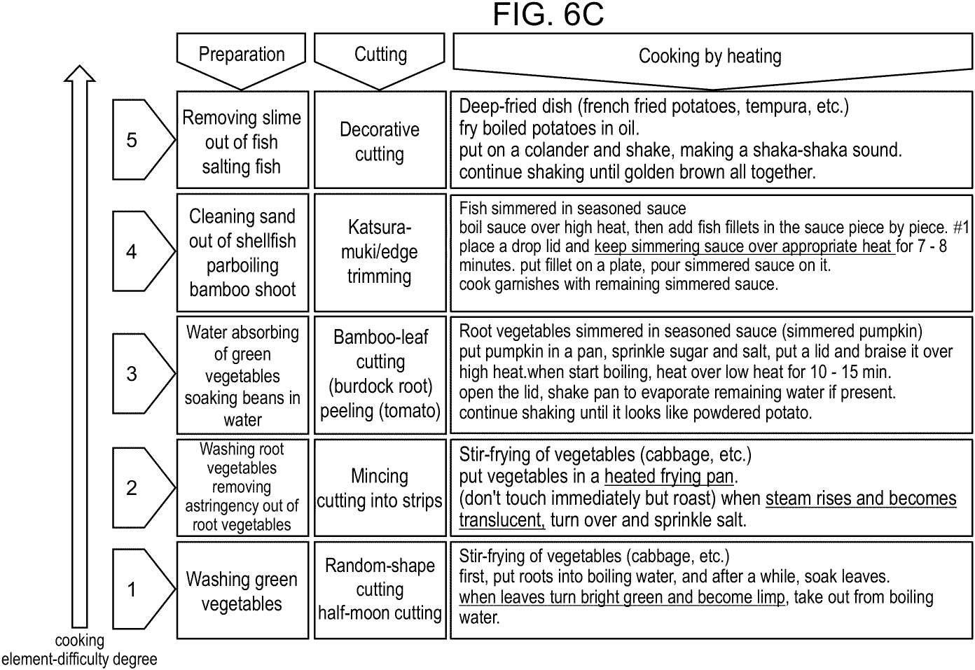

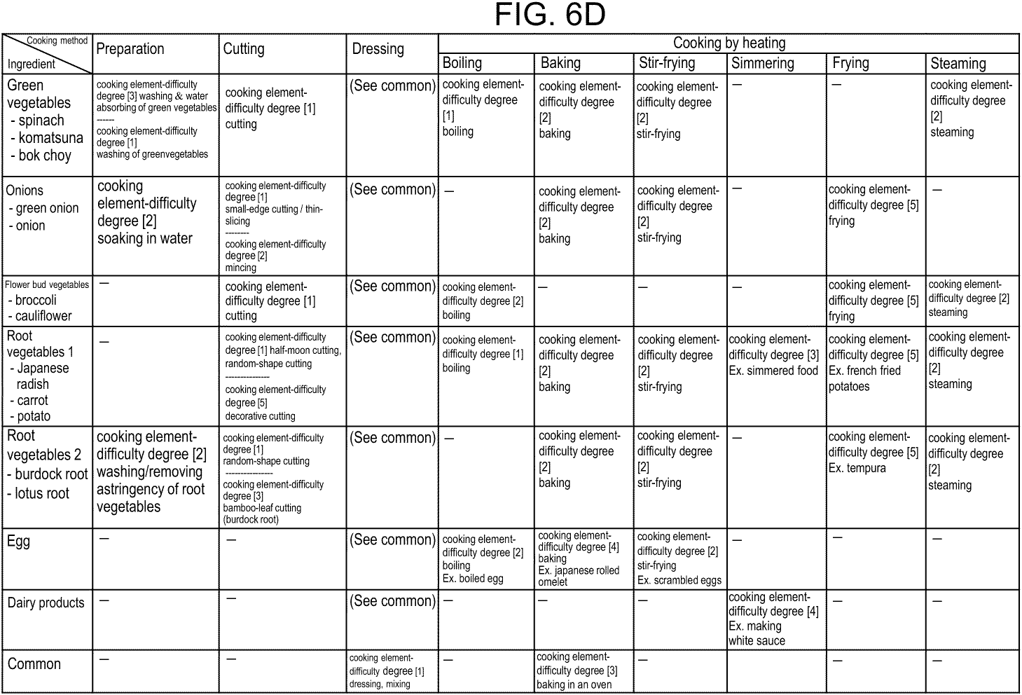

FIG. 6A shows cooking elements that are ingredients only, and the cooking element-difficulty degrees of the cooking elements. As shown in FIG. 6A, the cooking elements are ingredients only, such as “Green vegetables,” “Onions,” and “Egg.” For example, the cooking elements “Green vegetables,” “Onions,” and “Egg” have the cooking element-difficulty degrees “2,” “1 (one),” and “4,” respectively.

FIG. 6B shows cooking elements that are cooking methods only, and the cooking element-difficulty degrees of the cooking methods. As shown in FIG. 6B, the cooking elements are cooking methods only, such as “Cutting,” “Boiling,” and “Frying.” For example, the cooking methods “Cutting,” “Boiling,” and “Frying” have the cooking element-difficulty degrees “2,” “1 (one),” and “5,” respectively.

FIG. 6C shows cooking elements that include combinations of ingredients and cooking methods, and the cooking element-difficulty degrees of the cooking elements. As shown in 6C, the cooking elements may be combinations of ingredients and cooking methods such as “Vegetables × Boiling,” and “Cabbage × Cutting into strips,” or may be cooking methods such as “ Decorative cutting.” These cooking elements have the respective cooking element-difficulty degrees “1 (one),” “2,” and “5.”

FIG. 6D shows cooking elements that include ingredients, cooking methods, and combinations of ingredients and cooking methods, and the cooking element-difficulty degrees of the cooking elements. As shown in FIG. 6D, for example, the cooking element-difficulty degree of the cooking element “Dressing” or “Mixing” is “1 (one).” The cooking element-difficulty degree of the cooking element “Green vegetables × Stir-frying” is “2.”

In Step S200 described above, controller 16 calculates the sum total, maximum value, or average value of the cooking element-difficulty degrees of the cooking elements that correspond to the cooking processes in a recipe, and sets the thus-calculated value as the recipe-difficulty degree corresponding to the recipe. For example, the recipe “Boiled Spinach with a Katsuobushi and Soy Sauce Dressing” shown in FIG. 3 includes the cooking processes that correspond to the respective cooking elements “Green vegetables × Cutting,” “Green vegetables × Washing & Water-absorbing,” and “Green vegetables × Boiling.”

As shown in FIG. 6D, the cooking element-difficulty degrees of the cooking elements “Green vegetables × Washing & Water-absorbing,” “Green vegetables × Cutting,” and “Green vegetables × Boiling” are “3,” “1 (one),” and “1 (one),” respectively. Controller 16 calculates the sum total “5,” maximum value “3,” or average value “1.7” of these cooking element-difficulty degrees, and sets the thus-calculated value as the recipe-difficulty degree of the recipe “Boiled Spinach with a Katsuobushi and Soy Sauce Dressing.”

In one example, controller 16 weights the cooking-element reference levels of specific cooking elements, such as “Cutting,” “Mixing,” and “Heating,” and then calculates a recipe-difficulty degree.

In one example, in the case where cooking elements are the same in a plurality of recipes, these cooking element-difficulty degrees are common. In the case where the same cooking elements are included in a plurality of recipes mutually different, the recipe-difficulty degrees of these recipes are calculated based on the common cooking element-difficulty degree of the same cooking elements.

In another example, controller 16 may calculate the recipe-difficulty degree based on a parameter other than the cooking element-difficulty degree. For example, controller 16 may calculate, for the cooking process in a recipe, the number of written characters, the number of cooking processes, the number of ingredients used, required cooking time, or a combination of at least two thereof, and may set the thus-calculated value as the recipe-difficulty degree corresponding to the recipe.

This is because, in a recipe, the larger the number of written characters, number of cooking processes, or number of ingredients used is, or the longer the required cooking time is, the more the content of the recipe is complicated. This results in a higher difficulty degree.

Controller 16 may calculate the recipe-difficulty degree based on any combination of the cooking element-difficulty degree corresponding to the recipe and any one of the number of written characters, number of cooking processes, number of ingredients used, and required cooking time. For example, controller 16 may calculate the recipe-difficulty degree by combining the number of cooking processes in the recipe and the average value of the cooking element-difficulty degrees of the cooking elements that correspond to the cooking processes in the recipe.

In Step S300 described above, controller 16 may set, as items of a chart, the cooking elements corresponding to the cooking processes in a recipe, and cause information presenter 14 to present the cooking element-difficulty degrees that correspond to the respective items. This allows the presentation of the recipe-difficulty degree by using the chart.

One chart may be used to present the cooking element-difficulty degrees of a plurality of recipes that has at least one common cooking element. The chart referred to herein is a straight table, a radar chart, a vertical bar graph, a horizontal bar graph, an area chart, a line graph, a pie chart, or the like. The presented chart (e.g., radar chart) as a whole is referred to as “the recipe-difficulty degree.”

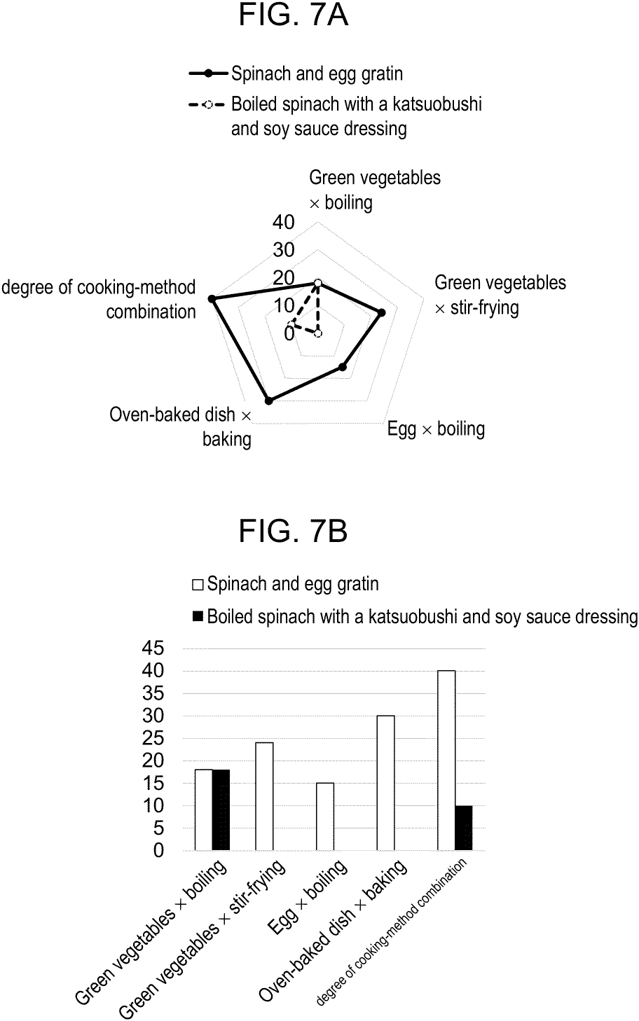

FIG. 7A shows the recipe-difficulty degrees that are presented using a radar chart. In the radar chart, a plurality of axes corresponds to respective cooking elements. By presenting the cooking element-difficulty degrees on the respective axes, the radar chart as a whole presents the recipe-difficulty degree of the recipe.

FIG. 7A shows a plurality of the cooking element-difficulty degrees of recipes “Spinach and Egg Gratin” and “Boiled Spinach with a Katsuobushi and Soy Sauce Dressing” simultaneously in one radar chart.

In the case where a recipe does not have any cooking process corresponding to the cooking element, i.e., the axis of the radar chart, the cooking element has a cooking element-difficulty degree of “0 (zero).” In FIG. 7A, such cooking elements are, for example, the cooking elements “Green vegetables × Stir-frying,” “Egg × Boiling,” and “Oven-baked dish × Baking” which are not present in the recipe “Boiled Spinach with a Katsuobushi and Soy Sauce Dressing.”

FIG. 7B shows the recipe-difficulty degrees that are presented using a vertical bar graph. A bar graph as well can present the cooking element-difficulty degrees of a plurality of recipes which has at least one common cooking element. As in the case of FIG. 7A, in the absence of the cooking process corresponding to the cooking element expressed along the axis (horizontal axis in FIG. 7B) of the bar graph, the cooking element has a cooking element-difficulty degree of “0 (zero).”

Controller 16 may use a parameter other than the cooking element-difficulty degree as an item of the chart. Such a parameter other than the cooking element-difficulty degree includes, in a recipe, the number of written characters, the number of cooking processes, the number of ingredients used, and a chart of required cooking time.

For example, as shown in FIGS. 7A and 7B, controller 16 causes “the degree of cooking-method combination” of each recipe to be presented as the cooking element-difficulty degree. “The degree of cooking-method combination” is an index that indicates the complexity and busyness of cooking. “The degree of cooking-method combination” is, for example, the number of cooking methods involved in a recipe, or the number of cooking elements to be performed in parallel in the course of the cooking.

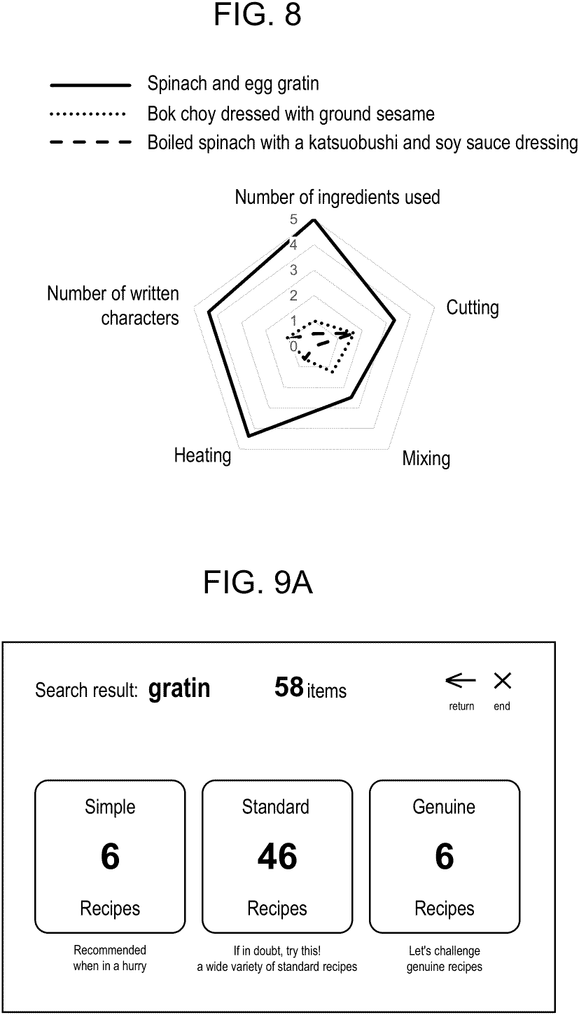

FIG. 8 shows the recipe-difficulty degrees that are presented in terms of items other than the cooking element-difficulty degrees. As shown in FIG. 8, controller 16 calculates, in a recipe, the number of written characters, the number of cooking processes of “Heating,” the number of cooking processes of “Mixing,” or the number of cooking processes of “Cutting.” Controller 16 causes information presenter 14 to present these pieces of information by using a radar chart.

The presentation of these items including the cooking element-difficulty degrees of the cooking elements and the number of written characters of the recipe, results in ease of understanding of not only the recipe-difficulty degree of the whole recipe but also the cooking element-difficulty degree of each cooking element. For this reason, a cook can easily determine whether or not the recipe is appropriate to implement for the cook’s self.

In one example, controller 16 classifies the recipe-difficulty degrees into a plurality of difficulty-degree classes by using at least one difficulty-degree classification threshold value. Controller 16 causes information presenter 14 to present the difficulty-degree classes along with the recipes and recipe-difficulty degrees thereof. The difficulty-degree classification threshold value is a threshold for use in classifying the recipe-difficulty degrees into a plurality of difficulty-degree classes.

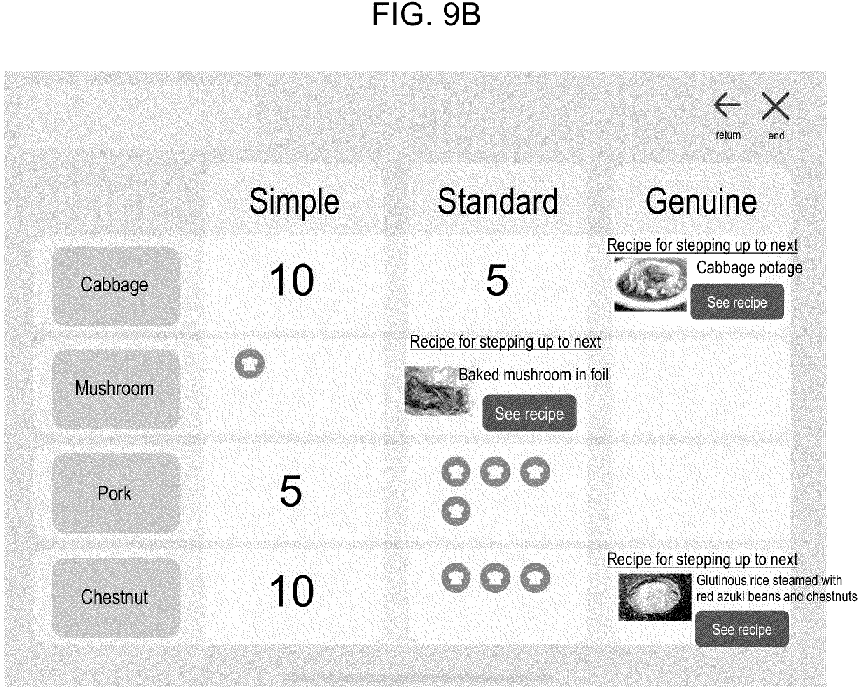

FIGS. 9A and 9B show the recipes and recipe-difficulty degrees which are presented in multiple grades. In the examples shown in FIGS. 9A and 9B, the recipe-difficulty degrees are classified into difficulty-degree classes in three grades “Simple,” “Standard,” and “Genuine” according to two difficulty-degree classification threshold values.

When presenting recipes and recipe-difficulty degrees, controller 16 avoids direct presentation of them, but firstly presents the difficulty-degree classes in three grades and the number of recipes that belong to each of the difficulty-degree classes. In the case shown in FIG. 9A, controller 16 causes information presenter 14 to present the search result for gratins as follows: The number of recipes with the recipe-difficulty degrees belonging to “Simple” is 6, the number of recipes with the recipe-difficulty degrees belonging to “Standard” is 46, and the number of recipes with the recipe-difficulty degrees belonging to “Genuine” is 6.

Upon a cook’s selection of any of the difficulty-degree classes, controller 16 changes the screen shown in FIG. 9A into a screen, like one shown in FIG. 4A, on which recipes and the recipe-difficulty degrees thereof (recipe reference levels) are presented.

In the example shown in FIG. 9B, recipes relating to a plurality of ingredients are presented in three grades of difficulty-degree classes. In the case where larger than a certain number (e.g., 5) of recipes are included in a specific difficulty-degree class, the number of the recipes included in the specific difficulty-degree class is presented by the numeric value. In the case where the specific difficulty-degree class includes smaller than the certain number of recipes, the number of the recipes is presented by the same number of symbols or marks as the number of the recipes.

FIG. 9B shows three recipes, for example, that use an ingredient “Chestnut” and have the difficulty degree belonging to “Standard.” As shown in FIG. 9B, the three symbols present that “three recipes are available.” In the case where, like the recipe “Baked Mushroom in Foil,” there is only one recipe that falls into a bracket, the one recipe is directly presented. Like this, in the case where there is a recipe appropriate for the next cooking of the cook (that is, proposed recipe 50 to be described later), such a recipe is also directly presented.

In the second embodiment, as a recipe reference level for use in determining the features of a recipe, a recipe-difficulty degree is presented along with the recipe to a cook. Since the cooking element-difficulty degree is determined for a specific ingredient, a specific cooking method, or a specific cooking element, the recipe-difficulty degree is accurately calculated based on the cooking element-difficulty degree. Such a reference as well can be easily understood by the cook.

In the case where the cooking element-difficulty degree is presented by using a chart, easily understandable is not only the recipe-difficulty degree of the whole recipe but also the cooking element-difficulty degree relating to the content of the recipe. For this reason, the cook can easily determine whether or not the recipe is appropriate to implement for the cook’s self.

An additional presentation of the numbers of written characters, numbers of cooking processes, numbers of ingredients used, or required cooking time, which all are in recipes, allows the cook to select an appropriate recipe more easily. The presentation of the recipe in multiple grades of the difficulty-degree classes allows the cook to understand the recipe-difficulty degree roughly and easily, resulting in further ease of selecting a recipe.

### Third Exemplary Embodiment

Hereinafter, a cooking-learning support system and a cooking-learning support method, both according to a third exemplary embodiment of the present disclosure, will be described with reference to the drawings. In the cooking-learning support system and the cooking-learning support method, both according to the third embodiment, supplementary information relating to the recipe-difficulty degree is further presented.

In the third embodiment, storage 12 stores supplementary information that corresponds to at least one recipe. The supplementary information referred to herein is information that relates to the ingredient or cooking method of a recipe and that relates to the recipe-difficulty degree of the recipe. That is, the supplementary information is information that indicates the basis for the recipe’s having the recipe-difficulty degree.

For the recipe having the recipe-difficulty degree that is not lower than a first difficulty-degree threshold value or is not higher than a second difficulty-degree threshold value lower than the first difficulty-degree threshold value, controller 16 causes information presenter 14 to present the supplementary information along with the recipe and recipe-difficulty degree thereof.

The supplementary information indicates the reason why the recipe has the recipe-difficulty degree. For example, a cooking element “Heating with a microwave oven” is so simple that it has a relatively low cooking element-difficulty degree (e.g., “1 [one]”). Accordingly, the recipe including “Heating with a microwave oven” has a relatively low recipe-difficulty degree as a whole. The cooking element “Frying” is so difficult that it has a relatively high cooking element-difficulty degree (e.g., “5” in FIG. 6B). Accordingly, the recipe including “Frying” has a relatively high recipe-difficulty degree as a whole.

For this reason, in one example, in the case where the recipe-difficulty degree of a presented recipe is not lower than the first difficulty-degree threshold value, the supplementary information indicates that the presented recipe includes a cooking process that corresponds to a cooking element-difficulty degree not lower than a third difficulty-degree threshold value (e.g., “4”). In the case where the recipe-difficulty degree of a presented recipe is not higher than the second difficulty-degree threshold value, the supplementary information indicates that the presented recipe does not have any cooking process that corresponds to a cooking element-difficulty degree not higher than a fourth difficulty-degree threshold value (e.g., “2”).

That is, the cooking-learning support system according to the present embodiment is capable of presenting supplementary information relating to a cooking element that has a cooking element-difficulty degree not lower than the third difficulty-degree threshold value. Alternatively, the cooking-learning support system according to the present embodiment is capable of presenting supplementary information relating to a cooking element that has a cooking element-difficulty degree not higher than the fourth difficulty-degree threshold value.

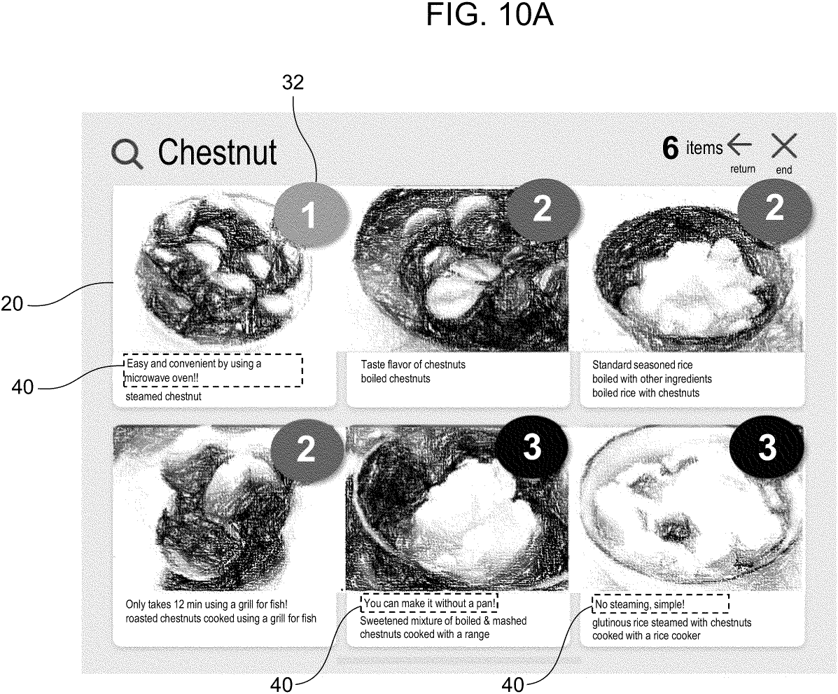

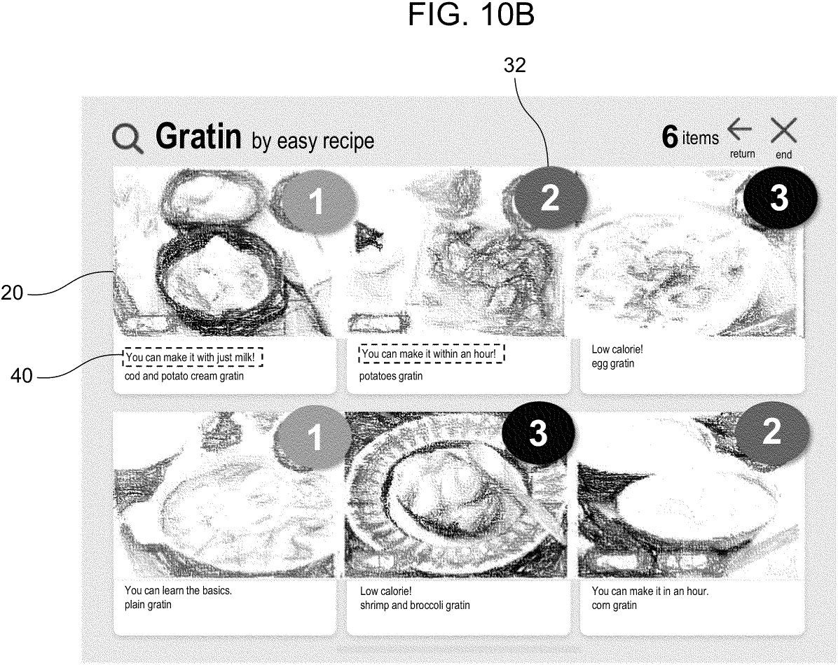

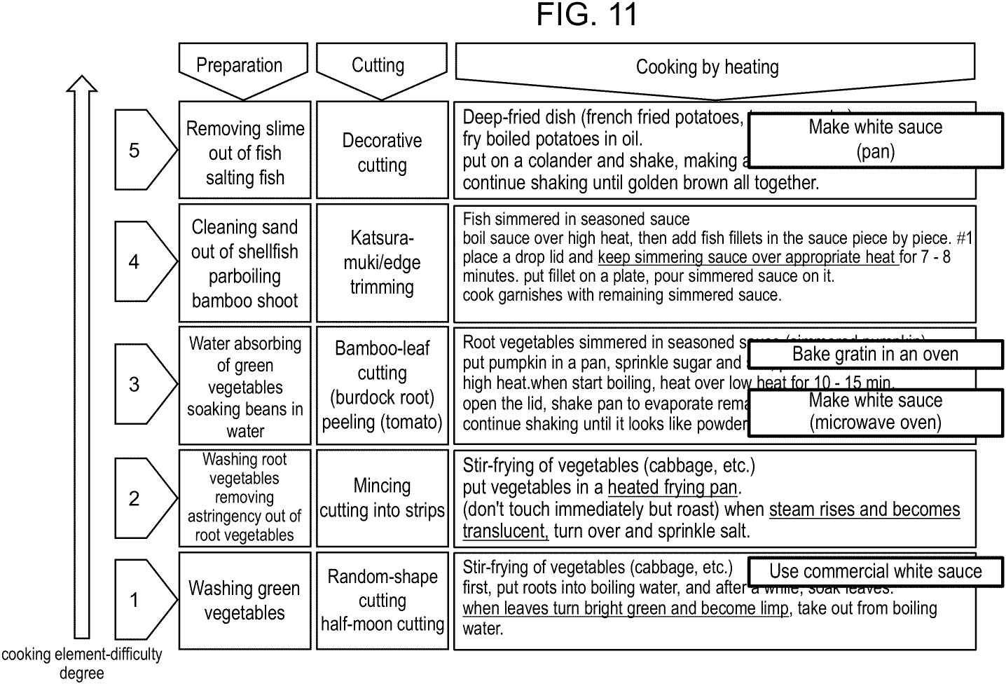

FIGS. 10A and 10B show supplementary information that is presented along with recipes and recipe-difficulty degrees. In FIGS. 10A and 10B, supplementary information 40 is characters enclosed by a dashed line. Supplementary information 40 is information relating to of recipe-difficulty degree 32 of recipe 20.

For example, as shown in FIG. 10A, the recipe “Steamed Chestnut” includes the cooking element “Heating with a microwave oven” and has a relatively low recipe-difficulty degree. Regarding the recipe, supplementary information 40 saying “Easy and convenient by using a microwave oven!!” is presented to a cook.

As shown in FIG. 10B, a recipe “Cod and Potato Cream Gratin” does not include such an ingredient having a high cooking element-difficulty degree as flour but includes milk, so that it has a relatively low recipe-difficulty degree. Regarding the recipe, supplementary information 40 saying “You can make it with just milk!” is presented to a cook.

In one example, supplementary information is presented in accordance with the relative difficulty degree of the recipe in a recipe group to which the recipe belongs. The recipe group contains a plurality of recipes for making the same dish although using different ingredients or different cooking methods, and is also called a dish group. A plurality of recipe included in the same recipe group may have different recipe-difficulty degrees.

For example, of a plurality of recipes for making the same dish, recipes including “Heating with a microwave oven” are lower in recipe-difficulty degree than recipes not including “Heating with a microwave oven.” Recipes using a commercial semi-finished product are lower in recipe-difficulty degree than recipes not using any commercial semi-finished product.

FIG. 11 shows a recipe group containing a plurality of recipes each of which has a different recipe-difficulty degree. In the example shown in FIG. 11, a recipe group “White sauce” contains four kinds of recipes. These recipes include cooking elements “Make white sauce (pan),” “Bake gratin in an open,” “Make white sauce (microwave oven),” and “Use commercial white sauce.”

As shown in FIG. 11, the cooking elements “Make white sauce (pan),” “Bake gratin in an open,” “Make white sauce (microwave oven),” and “Use commercial white sauce” have the cooking element-difficulty degrees “5,” “3,” “3,” and “1 (one),” respectively.

In this example, storage 12 stores the recipe group containing a plurality of recipes. In order to present supplementary information in accordance with relative difficulty degree of the recipe, controller 16 determines whether or not the recipe presented by information presenter 14 is contained in at least one recipe group.

In the case where the presented recipe is contained in the recipe group and the recipe-difficulty degree of the presented recipe is not higher than the second difficulty-degree threshold value described above, controller 16 causes at least one of the following two types of supplementary information to be presented.

The first type of the supplementary information indicates that the presented recipe does not include any designated ingredient that is included in the predetermined number of other recipes contained in the recipe group. The designated ingredient is an ingredient that can influence the recipe-difficulty degree. For example, the designated ingredient in the recipe group of white sauce is cheese or flour. The designated ingredient is included only in some recipes among the recipes contained in the recipe group.

The predetermined number described above can be expressed in terms of a ratio of such recipes to the recipe group. A case is exemplified in which the designated ingredient is “Cheese” and the predetermined number (for example, a half) of the recipes in the recipe group include the designated ingredient “Cheese.”

For the recipes that are contained in the recipe group “White sauce,” that have the recipe-difficulty degree not higher than the second difficulty-degree threshold value, and that do not include the designated ingredient “Cheese,” controller 16 may cause information presenter 14 to present the supplementary information “You can make it without cheese” along with the recipe and recipe-difficulty degree thereof.

The second type of the supplementary information indicates that the presented recipe includes a substitute cooking method or a substitute ingredient. The substitute cooking method referred to herein is a cooking method, having a low cooking element-difficulty degree, which can be used as a substitute for the cooking method that is included in more than a certain number (e.g., 5) of recipes in a recipe group and that has a high cooking element-difficulty degree. For example, in the recipe group “White sauce,” “Heating with a microwave oven” can be set as a substitute cooking method for “Heating with a pan.”

As in the case of the substitute cooking method, the substitute ingredient referred to herein is an ingredient, having a low cooking element-difficulty degree, which can be used as a substitute for the ingredient that is included in more than a certain number of recipes in a recipe group and that has a high cooking element-difficulty degree. For example, “Commercial white sauce” can be set as a substitute ingredient for “Flour,” “Butter,” and “Milk.”

For the recipe that is contained in the recipe group “White sauce,” that has the recipe-difficulty degree not higher than the second difficulty-degree threshold value, and that includes the substitute ingredient “Commercial white sauce,” controller 16 may cause information presenter 14 to present the supplementary information “You can make it with commercial white sauce” along with the recipe and recipe-difficulty degree thereof.

The presentation of supplementary information that indicates the basis for the corresponding recipe’s having the recipe-difficulty degree, allows a cook to easily understand the specific reference regarding the determination of the recipe-difficulty degree, which results in ease of being convinced of the recipe-difficulty degree.

The supplementary information is specific information as to whether or not the recipe includes a specific ingredient and cooking method, as to whether or not a substitute cooking method and a substitute ingredient are used, and as to any other information. Such specific information influences the recipe-difficulty degree. Therefore, the cook is easily convinced of the recipe-difficulty degree that is influenced by these pieces of information.

### Fourth Exemplary Embodiment

Hereinafter, a cooking-learning support system and a cooking-learning support method, both according to a fourth exemplary embodiment of the present disclosure, will be described with reference to the drawings. In the cooking-learning support system and the cooking-learning support method, both according to the fourth embodiment, the learning level of a cook is further presented.

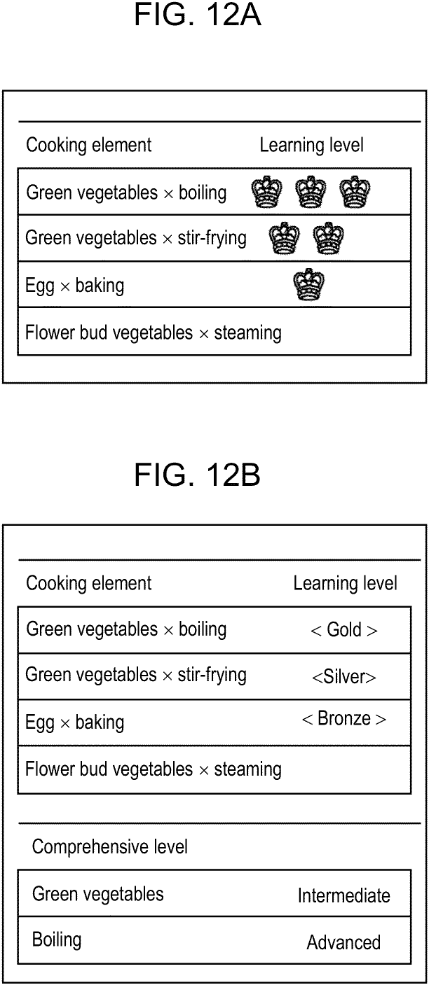

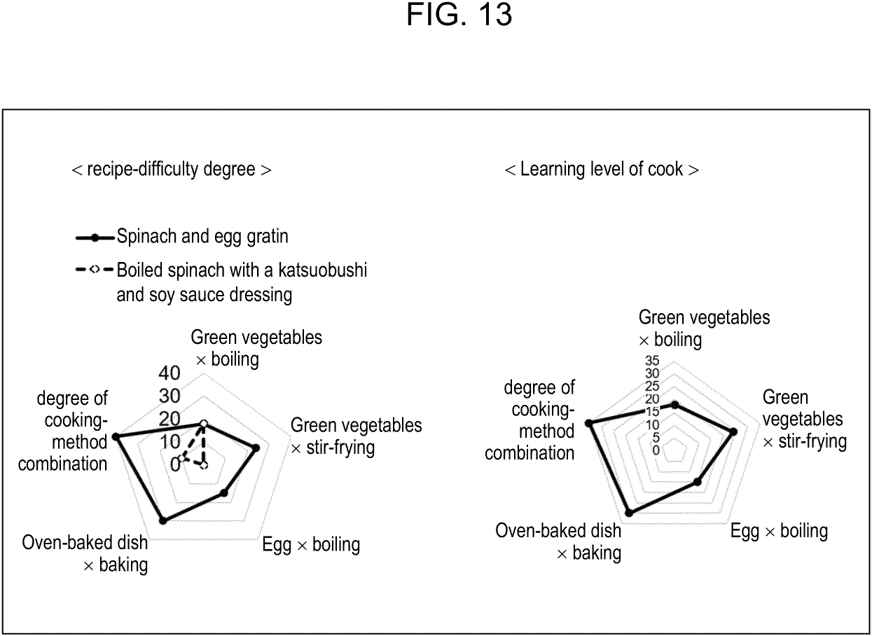

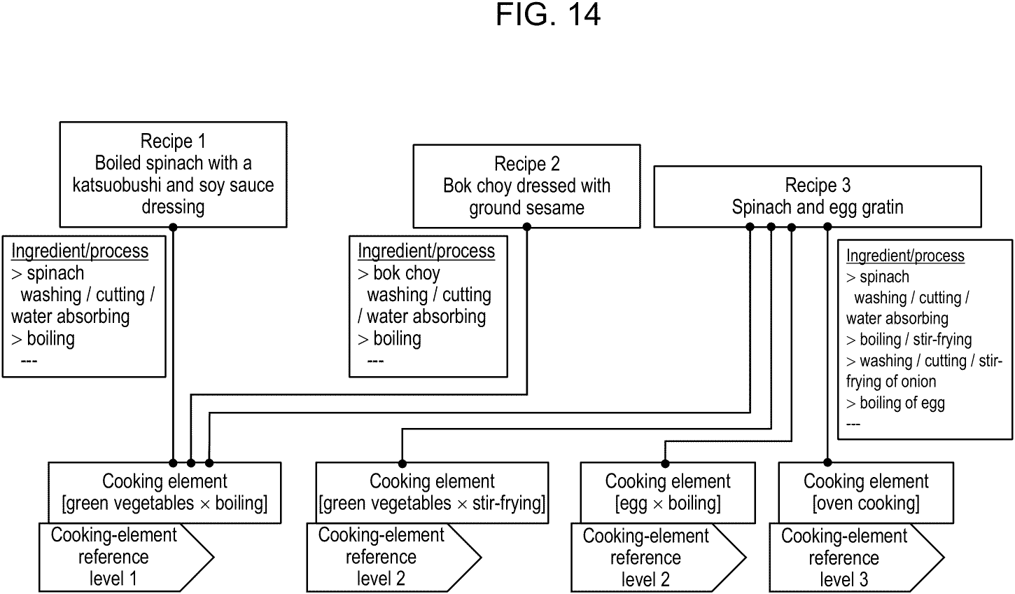

The learning level referred to herein is the level of a cook’s cooking skill for a specific cooking element, and is set for each cooking element. FIGS. 12A and 12B show visual presentation of learning levels. As shown in FIGS. 12A and 12B, the learning levels are expressed by means of expression in grades as follows: The expression is given in terms of, for example, positive integers “1-10,” “Advanced-level, Intermediate-level, and Beginner’s-level,” “Gold, Silver, and Bronze,” “Triple-stars, Double-stars, and Shingle-star,” or the like.

When reaching a higher learning level for a specific cooking element, the cook is more likely to be able to implement a recipe including the specific cooking element. For learning levels, an upper limit level (hereinafter, referred to as “Master”) is set which indicates that all the cooking element has been acquired.

Storage 12 stores the cook’s learning level for at least one cooking element. Controller 16 causes information presenter 14 to present the learning level along with the recipe and recipe-difficulty degree thereof.

FIG. 13 shows learning levels that are presented along with recipes and recipe-difficulty degrees thereof. As shown in FIG. 13, controller 16 causes the learning levels to be presented in conformity with items (such as cooking elements) and the type of chart (e.g., radar chart) indicating the recipe-difficulty degrees. Specifically, based on the cooking elements presented in the recipe-difficulty degrees, controller 16 acquires the learning levels by collating the cook’s learning levels corresponding to the cooking elements, and causes the thus-acquired learning levels to be present.

Since the recipe-difficulty degrees and the learning levels are presented at the same time, it results in ease of understanding both the learning levels and the differences between the learning levels and the recipe-difficulty degrees. For example, the chart on the left side of FIG. 13 presents the recipes “Boiled Spinach with a Katsuobushi and Soy Sauce Dressing” and “Spinach and Egg Gratin” and the recipe-difficulty degrees of the respective recipes. The chart on the right side of FIG. 13 presents the cook’s current learning levels.

By comparting the two charts, the cook can understand the learning levels of the cook’s self. In the case where the radar chart of the learning levels is equal or larger than the radar chart of the recipe-difficulty degrees, the cook can expect and recognize that the cook is capable of implementing the recipe without any problem.

Controller 16 causes information presenter 14 to visually present at least one of the recipe-difficulty degree, the cooking element-difficulty degree, and the learning level, by using visual elements such as a character, an image, an icon, a bar graph, and a line graph. This allows the cook to easily grasp the difficulty degrees of the recipes or cooking elements, the current status of learning, and the cooking elements to be learned from now on.

Visually recognizing a rise in learning levels allows the cook to have a feeling of achievement, thereby increasing the cook’s motivation for the next learning. Not presenting the cooking elements, ingredients, cooking methods which all have been learned, as being unnecessary information, allows a decrease in amount of information to be presented.

In one example, controller 16 may automatically set learning levels for the cooking elements stored in storage 12. Controller 16 may automatically set the initial values of the learning levels equal to 0 (zero).

For example, controller 16 stores, in storage 12, the number of cooking times of the recipe or cooking element that the cook has implemented, as a cooking record. The number of cooking times means that the cook has cooked the recipe or cooking element the number of times.

In one example, the cooking record contains the number of cooking times and the cooking date. Each time the recipe is implemented, controller 16 updates the number of cooking times stored in storage 12. Controller 16 compares the number of cooking times of each of the cooking elements with a predetermined threshold value. In the case where the number of cooking times becomes not smaller than the threshold value, controller 16 raises the learning level for the cooking element and causes storage 12 to store the raised learning level.

The threshold value for the number of cooking times is set for each of the cooking elements. The predetermined number of times for a hard-to-learn cooking element is set larger than that for an easy-to-learn cooking element. For example, threshold values of the numbers of cooking times are set such that a threshold value of five times is set for a hard-to-learn cooking element, and a threshold value of one time is set for an easy-to-learn cooking element.

In the case where the same recipe or cooking element is presented again, controller 16 causes information presenter 14 to present these pieces of information along with the recipe-difficulty degree in accordance with the updated learning levels.

In another example, after the cooking is finished, controller 16 causes storage 12 to store, as a cooking record, the finished quality of the result of the cooking, and automatically changes the learning level based on the finished quality. The result of the cooking is evaluated for quality by the cook, a third party, or an apparatus having a function and structure for evaluating dishes.

In further another example, in the case where the same cooking element is included in each of a plurality of recipes, their cooking element-difficulty degrees are common. Regarding the same cooking element, upon implementing one or a plurality of recipes that includes a cooking process corresponding to the same cooking element, the cook’s learning level for the same cooking element is changed.

In the case where, after the cook has implemented one recipe, controller 16 updates the learning level for a cooking element included in the recipe, controller 16 also updates the learning level for other recipe that includes a cooking process corresponding to the cooking element the same as that in the one recipe, in the same manner as in the one recipe.

FIG. 14 expresses cooking elements that are common among a plurality of recipes, and commonality of each of the cooking elements. For a specific cook, a learning level is set for each of the cooking elements. One cooking element corresponds to a plurality of recipes. After cooking, controller 16 changes the learning level for a common cooking element based on the cooking record.

In further another example, in the case where like cooking elements are not common between at least two recipes, controller 16 sets different learning levels for the like cooking elements in the two recipes.

In yet another example, controller 16 causes learning levels to be presented for each cooking date or number of cooking times. In this example, storage 12 stores learning levels for each cooking date or number of cooking times, and controller 16 causes information presenter 14 to present the learning levels for each cooking date or number of cooking times. The cooking date is the date on which the specific recipe is implemented. The number of cooking times is the number of times the specific recipe has been implemented so far.

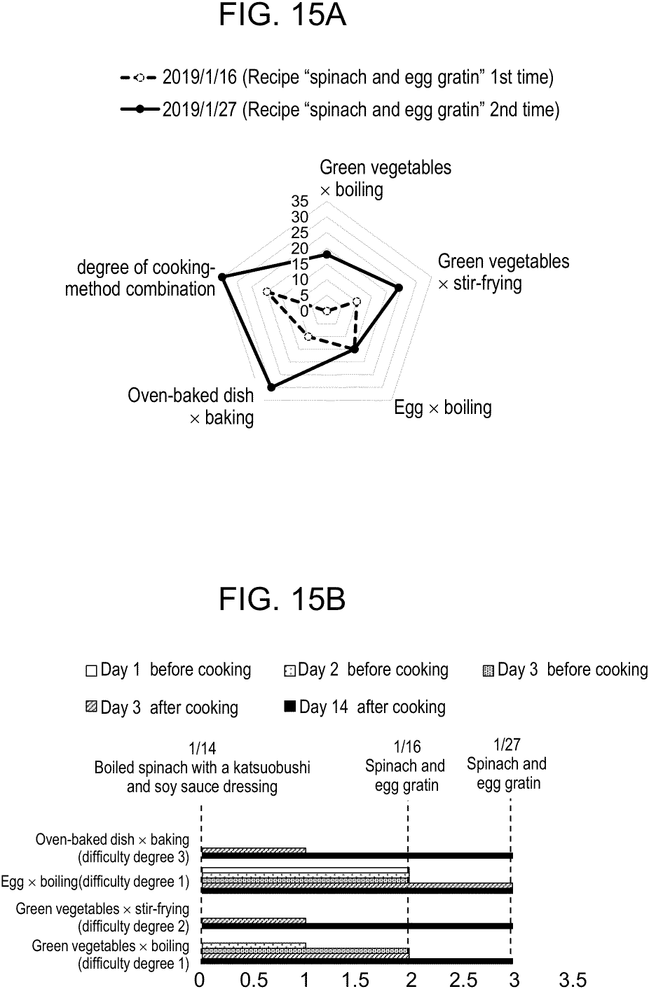

FIG. 15A shows the recipe-difficulty degrees presented in a radar chart for each cooking date and number of cooking times. As shown in FIG. 15A, when the cook implements the recipe “Spinach and Egg Gratin” for the first time, the learning levels for the cooking elements “Green vegetables x Boiling,” “Green vegetables x Stir-frying,” “Egg x Boiling,” “Open-baked dish × Baking,” and “Cooking-method combination” are respectively “0 (zero),” “10,” “15,” “10,” and “20.”

After the cooking, controller 16 automatically changes the learning levels for the cooking elements included in the recipe “Spinach and Egg Gratin.” When the cook implements the recipe “Spinach and Egg Gratin” again, the learning levels for the respective cooking elements described above are respectively “20,” “25,” “15,” “30,” and “35.”

In the case where, before the cook’s implementing the same recipe again, the cook implements another recipe that includes at least one common cooking element, controller 16 automatically changes the learning levels for the cooking element included in the another recipe, in the same manner as the above.

FIG. 15B shows the recipe-difficulty degrees that are presented in a horizontal bar graph, for each cooking date and number of cooking times. As shown in FIG. 15B, after the recipe “Boiled Spinach with a Katsuobushi and Soy Sauce Dressing” is implemented on January 14th, controller 16 changes the learning level for the cooking element “Green vegetables x Boiling” from “0 (zero)” to “1 (one).”

After the recipe “Spinach and Egg Gratin” is implemented on January 16th, controller 16 changes the learning level for the cooking element “Egg x Boiling” from “2” to “3.” After the recipe “Spinach and Egg Gratin” is cooked on January 27th, controller 16 changes all of the learning levels for the cooking elements “Oven-baked dish x Baking,” “Egg x Boiling,” “Green vegetables x Stir-frying,” and “Green vegetables x Boiling” to “3.”

The bar graph can also be used to provide the learning levels for each cooking date or number of cooking times. However, any type of chart other than the radar chart and bar graph, can also be used to present the learning levels and the recipe-difficulty degrees. It is also possible to present the learning levels and recipe-difficulty degrees only for each date or only for each number of cooking times.

By presenting the learning levels for each cooking date or number of cooking times, it is possible to present the cook with the achievement status of the learning level for each cooking element, in an easy-to-understand manner. It is also possible to clearly present the cooking elements that the cook is not good at, and the cooking elements that the cook should improve.

In the fourth embodiment, the cook’s learning levels are recorded, the cook’s learning levels are further presented, and, in particular, the cook’s learning levels are presented along with the recipe-difficulty degrees. The cook easily understands differences between the learning levels of the cook’s self and the recipe-difficulty degrees of the recipe presented.

In presenting the learning levels, the presentation of additional information, such as the presentation for each cooking element and the presentation of the number of characters in a recipe, allows the cook to be provided with a further basis for determination. The learning levels can be automatically updated based on the number of cooking times for the same cooking element, leading to highly reliable information that reflects the progress of the cooking skill of the cook.

The learning levels as well are common among a plurality of recipes, causing the learning levels to be highly reliable information with consistency. Presentation of the learning levels for each cooking date and number of cooking times in a chart, allows the cook to understand the history of improvement of the cooking skill of the cook’s self and to easily decide the cooking elements to be improved next.

### Fifth Exemplary Embodiment

Hereinafter, a cooking-learning support system and a cooking-learning support method, both according to a fifth exemplary embodiment of the present disclosure, will be described with reference to the drawings. In the fifth embodiment, learning levels for cooking elements stored in storage 12 are set manually by a cook.

In the embodiment, upon receiving a learning level-setting command, via input part 18, for instructing to set a learning level for at least one cooking element, controller 16 sets the learning level for the at least one cooking element.

Initial values of learning levels are manually set by the cook. For example, with the cooking-learning support system and the cooking-learning support method, both according to the embodiment, there are defined labels such as “Beginner,” “Intermediate learner,” “Advanced learner,” “Housewife,” and “Undergraduate living alone.” For each label, initial values of learning levels for cooking elements are defined. Storage 12 stores these values.

When the cook uses the cooking-learning support system or the cooking-learning support method for the first time, the initial value of a learning level is set. For example, the cook uses input part 18 to select or input a label appropriate for the cook’s self, referring to a questionnaire and the like presented by information presenter 14. Based on the label, the initial value of a learning levels is set.

In the case where the cook sets an initial value via a user interface of information presenter 14, the initial value is set for at least one specific cooking element. The initial value may be set collectively for both or one of a specific ingredient and a specific cooking method.

For example, with the cooking-learning support system and the cooking-learning support method, there are presented items such as “Green vegetables dish,” “Egg dish,” “Simmered dish,” “Grilled dish,” and “Cooking in general.” Regarding at least one item, controller 16 sets an initial value of the learning level for the cooking element, in accordance with the learning level that has been selected or directly inputted by the cook using input part 18.

For example, in the case where the cook inputs “Intermediate-level” for “Green vegetables dish,” controller 16 sets the initial values of learning levels for all of the cooking elements including “Green vegetables x Preparing” and “Green vegetables x Boiling” such that their initial values are of “Intermediate-level.”

In one example, even after controller 16 has presented both or one of the recipe-difficulty degree and the learning level, the cook sets an initial value of the learning level by manually setting the current value of the learning level as the initial value.

Controller 16 determines whether or not it has received a learning level-setting command via input part 18. Upon receiving the learning level-setting command, controller 16 sets the learning level for the cooking element.

For example, information presenter 14 presents an interface for setting, and then the learning level is set for at least one specific cooking element via input part 18. The learning level may be set collectively for both or one of a specific ingredient and a specific cooking method.

In the case where the learning level designated by the learning level-setting command is different from the information stored in storage 12, the stored learning level is changed according to the learning level-setting command.

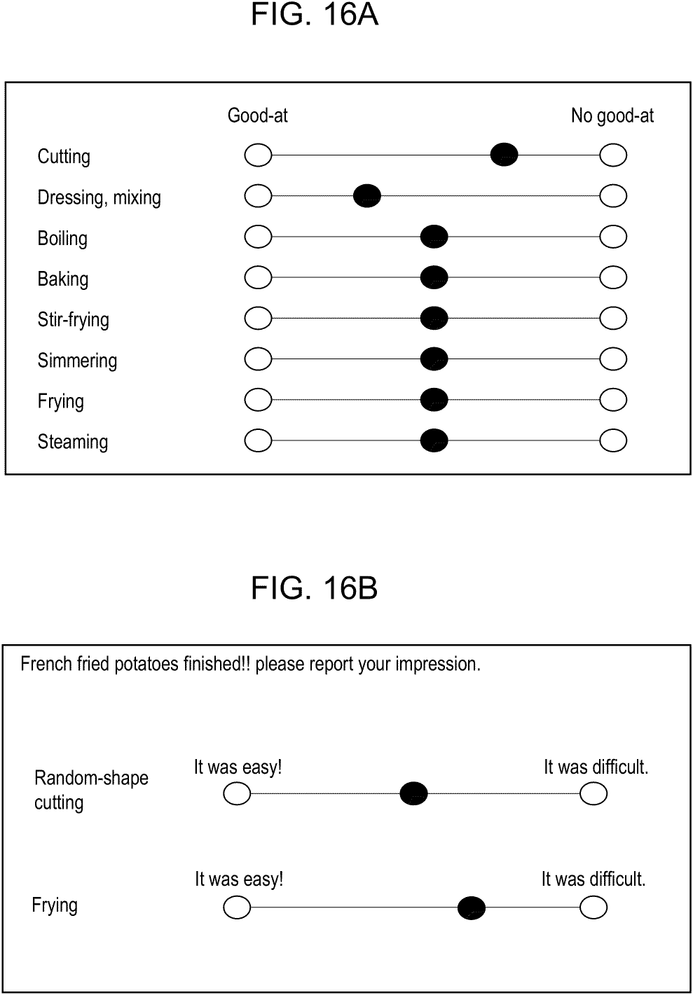

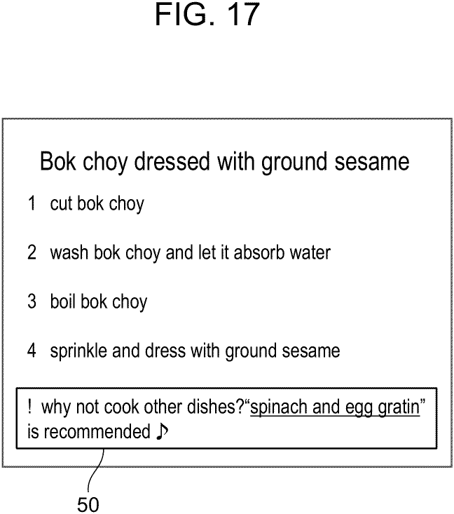

FIG. 16A shows one example of a user interface for use in inputting a learning level-setting command. As shown in FIG. 16A, in this user interface, each of a plurality of cooking elements has a horizontal bar and an icon represented by a black circle displayed on the bar. By moving the icon along the bar in a lateral direction, the cook sets a learning level-setting command.

Controller 16 causes “Good at” and “No good at” displayed at the both ends of the bar to correspond to the learning level-setting commands “10” and “0 (zero),” respectively, and sets the numerical value according to the position of an icon as the learning level-setting command.

After the cooking is finished, controller 16 requests the cook to input feedback on the cooking. Controller 16 receives the feedback as a learning level-setting command, and changes the learning level based on the feedback.

FIG. 16B shows another example of a user interface for use in inputting a learning level-setting command. As shown in FIG. 16B and as in the case of FIG. 16A, the cook sets feedback (learning level-setting command) by moving the icon along the bar in a lateral direction.

Controller 16 causes “It was easy!” and “It was difficult” displayed at the both ends of the bar to correspond to the learning level-setting command “10” and “0 (zero),” respectively, for example, and sets the numerical value according to the position of the icon as the learning level-setting command.

In this example, the situation where the higher the numerical value of the learning level-setting command, the higher the learning level is, means that the cook is more likely to be able to implement the corresponding cooking element.

In the case where the same recipe or cooking element is presented again, controller 16 causes information presenter 14 to present the recipe or cooking element along with the recipe-difficulty degree and the like in accordance with the changed learning level.

In the fifth embodiment, the learning level can be manually set by the cook. For this reason, it is possible to set the more accurate learning level according to the cook’s feeling.

### Sixth Exemplary Embodiment

Hereinafter, a cooking-learning support system and a cooking-learning support method, both according to a sixth exemplary embodiment of the present disclosure, will be described with reference to the drawings.

With the cooking-learning support system and the cooking-learning support method, both according to the sixth exemplary embodiment, in order to cause the cooking skill of the cook to improve, at least one recipe is proposed as proposed recipe 50 from among a plurality of recipes stored in storage 12.

In one example, controller 16 causes the search result for recipes relating to a specific cooking element to be presented as proposed recipes 50. As shown in FIGS. 4A, 4B, 10A, or 10B, the cook uses a user interface to search for recipes regarding a specific cooking element (for example, “Chestnut” and “Gratin”).

At that time, controller 16 causes the thus-searched recipes to be presented along with proposed recipes 50, which both are accompanied with their recipe-difficulty degrees (recipe reference levels). This allows the cook to easily determine whether or not proposed recipes 50 are appropriate for the cook’s self, resulting also in easy selection of a recipe to be implemented next from among a plurality of proposed recipes 50.

In another example, controller 16 causes information presenter 14 to present recipes, as proposed recipes 50, from among a plurality of recipes stored in storage 12, such presented recipes which include the cooking elements each having the cooking element-difficulty degree that is higher than the learning level by a predetermined degree.

In this example, the cooking element-difficulty degrees represent the order of priority in which the cooking elements have to be learned. For example, in general, among various cooking elements of the same kind that relates to a cooking element “Cutting,” “Heating,” or the like, challenging to a cooking element with a higher difficulty degree without having learned other cooking element with a lower difficulty degree, is highly likely to result in a failure.

Therefore, the lower the cooking element-difficulty degree, the higher the priority of learning is set. For example, in FIG. 6C, of the cooking elements relating to “Cutting,” the cooking element-difficulty degree of “Katsura-muki” is higher than that of “Random-shape cutting.” That is “Katsura-muki” is more difficult to learn than “Random-shape cutting.” Therefore, “Random-shape cutting” is set higher in priority of learning than “Katsura-muki.” “Katsura-muki” referred to herein is peeling the skin of a cylinder-shape cut Japanese radish, carrot, etc., with a kitchen knife.

When the cook is found to achieve a certain degree of improvement in skill for a cooking element having a relatively-low cooking element-difficulty degree, controller 16 causes a recipe to be presented, as proposed recipe 50, that includes the cooking element having a slightly higher cooking element-difficulty degree than the achieved cooking element, that is, this element in proposal is a slightly more difficult than the achieved one. Such a certain degree of improvement in skill means, for example, that the learning level has reached “Master.”

The situation where proposed recipe 50 includes a cooking element more difficult by a predetermined degree means that the difference between the learning level and the cooking element-difficulty degree of at least one cooking element included in proposed recipe 50 is within a predetermined degree.

An example is described in which, as shown in FIG. 6C, the cooking element-difficulty degrees “1 (one)” to “5” are set, one for each cooking element, and the “predetermined degree” is set to “2.” In this case, a cooking element the following difference of which is within “2” is set as the cooking element to be learned next. That is, the difference is between the cooking element-difficulty degree of the cooking element to be learned next and the cooking element-difficulty degree of the cooking element which has already been learned or is currently being learned.

It is desirable for controller 16 to make a proposal in consideration of the difference between the difficulty degrees such that the cooking element-difficulty degree of a cooking element included in proposed recipe 50 is not excessively higher than the learning level of the cook.

FIG. 17 shows the presentation of a proposed recipe. As shown in FIG. 17, the example will be described in which the learning level of the cook is “Master” about the cooking elements (“Green vegetables x Preparing” and “Green vegetables x Boiling”) relating to a recipe “Bok Choy Dressed with Ground Sesame.”

Likewise, for example, the recipe “Spinach and Egg Gratin” includes the cooking elements “Green vegetables x Preparing” and “Green vegetables x Boiling.” This recipe further includes the cooking elements “Onions x Preparing” and “Egg x Boiling” whose ingredient or cooking method is common to those of the recipe described above, and the cooking elements “Green vegetables x Stir-frying” whose cooking element-difficulty degree is higher by a predetermined degree than those of the recipe described above (see FIG. 6C).

Therefore, controller 16 set the recipe “Spinach and Egg Gratin” as proposed recipe 50 (see FIG. 17), and causes information presenter 14 to present its name.

Upon clicking of the presentation mark that represents proposed recipe 50, controller 16 may change the screen presented by information presenter 14 to a screen for presenting the cooking process in proposed recipe 50. In the case where there is a plurality of proposed recipes 50, controller 16 may cause information presenter 14 to present the plurality of proposed recipes 50 on a transition screen changed from the presentation mark that is used in place of the names of proposed recipes 50.

The presentation of proposed recipe 50 along with its recipe-difficulty degree allows the cook to easily determine whether or not proposed recipe 50 is appropriate for the cook’s self, resulting also in easy selection of a recipe appropriate for the next cooking.

If proposed recipe 50 is determined in accordance with the learning level of the cook, it makes possible the selection of a cooking that is slightly more difficult than the cook’s own cooking skill. As a result, the cook can improve the cook’s own cooking skill without losing motivation for cooking.

### Seventh Exemplary Embodiment

Hereinafter, a cooking-learning support system and a cooking-learning support method, both according to a seventh exemplary embodiment of the present disclosure, will be described with reference to the drawings.

With the cooking-learning support system and the cooking-learning support method, both according to the seventh embodiment, the cooking-element reference level and the recipe reference level are respectively the cooking element-participation degree and the recipe-participation degree, which both are of the corresponding cooking element and the corresponding recipe and are for a second cook.

In the seventh to fourteenth embodiments, the second cook is a child, and a first cook is a person who assists the second cook in cooking, such a person being a parent, teacher, nursery teacher, or the like, for example.

In the embodiment, the degree of participation referred to herein is the de*gree indicating the extent to which the second cook of the specific age can participate in the implementation of a specific cooking element or recipe. The cooking element-participation degree referred to herein is the degree of participation of a specific cooking element for the second cook of the specific age.

For example, the cooking element-participation degree of a cooking element “Vegetables x Cutting” referred to herein is the degree indicating the extent to which the second cook of the specific age can participate in the implementation of this specific cooking element. The specific age is, e.g., five years or younger. That is, the second cook of the specific age is a preschool child.

The cooking element-participation degree may also be considered to indicate the de*gree of learning of the cooking element by the second cook of the specific age. In one example, the cooking element-participation degree indicates whether or not the second cook of the specific age can participate in the implementation of the cooking element. In the case of the second cook being able to implement the cooking element, it is expressed that the second cook can participate in the cooking element. The situation where the second cook can participate is represented by “1 (one),” “TRUE,” “POSSIBLE,” or the like.

In the case of the second cook being not able to implement the cooking element, it is expressed that the second cook cannot participate in the cooking element. The situation where the second cook cannot participate is represented by “0 (zero),” “FALSE,” “IMPOSSIBLE,” or the like.

In another example, the cooking element-participation degree is expressed not by digital-like expression such as “1 (one) or 0 (zero),” but by percentages such as “##%” or stepwise numerical values such as “¼,” “⅓,” or “⅔,” for example.

For example, controller 16 sets the required number N of learning times for a cooking element. Controller 16 sets the upper limit of the cooking element-participation degree equal to “N/N = 1,” and increases the cooking element-participation degree by “⅟N” each time the cooking element is implemented. The required number N of learning times is set for each cooking element.

In one example, in the case where the same cooking elements are included in a plurality of recipes, their cooking element-participation degrees are common. In the case where the recipe-participation degrees are calculated for different recipes that include a cooking process corresponding to the same cooking element, the calculation is done using the same cooking element-participation degree of the same cooking elements. This results in the calculation of the recipe-participation degree (recipe reference level) according to a consistent reference.

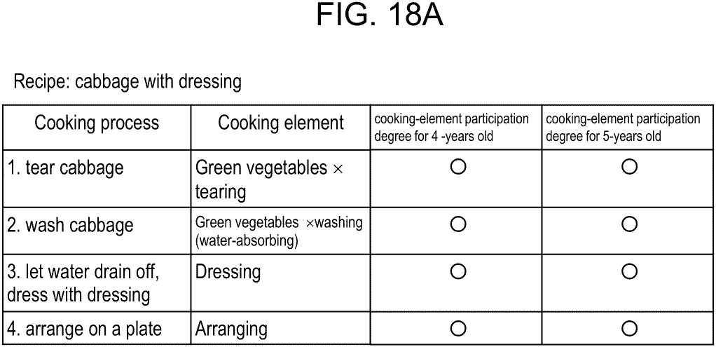

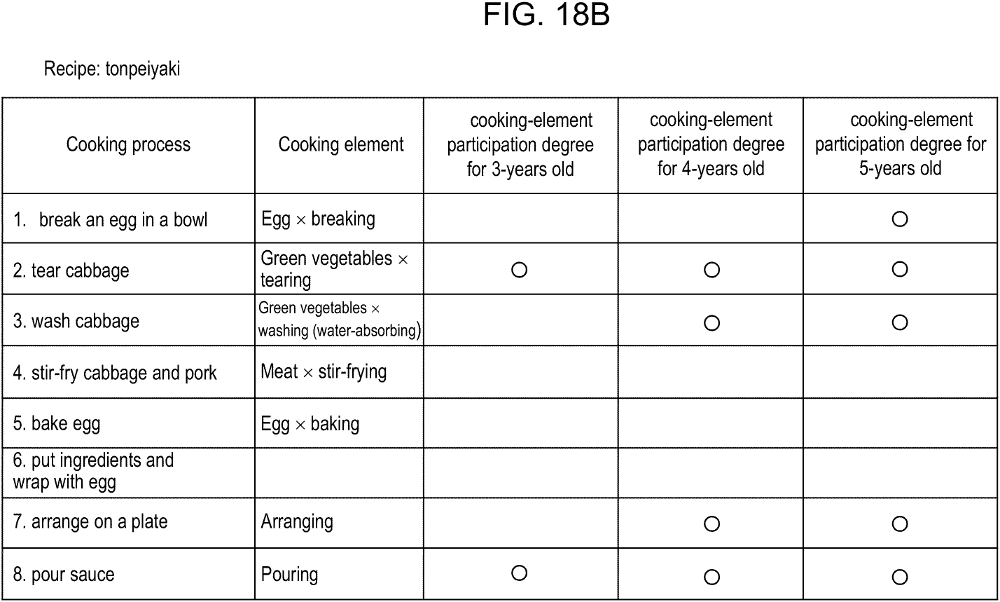

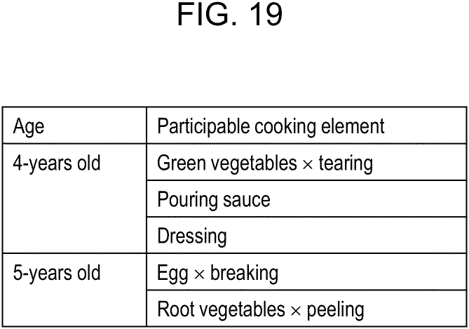

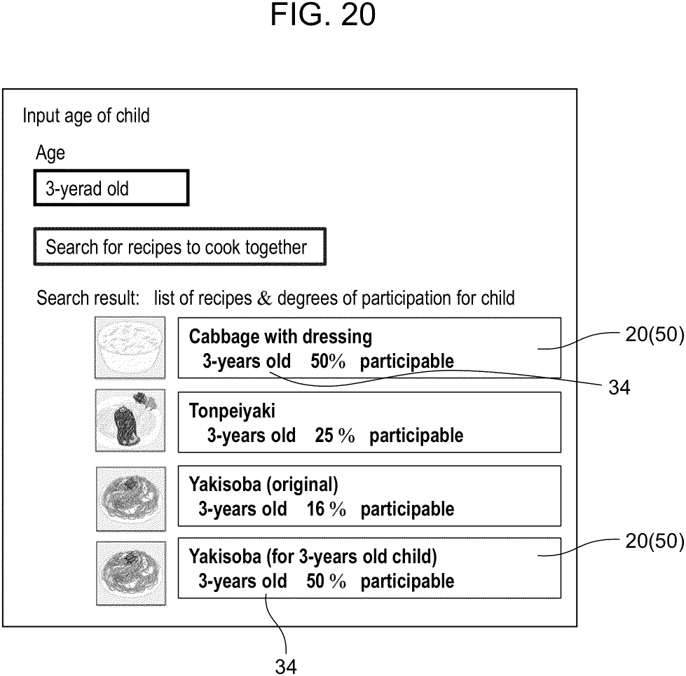

Storage 12 stores the cooking element-participation degree of each cooking element, with the degree corresponding to at least one specific age. FIGS. 18A and 18B each show the cooking element-participation degrees of cooking elements that are respectively included in recipes “Cabbage with Dressing” and “Tonpeiyaki.” The “Tonpeiyaki” is a dish made by wrapping a filling with egg, in an omelet-like way, with the filling including stir-fried pork and vegetables.

In FIGS. 18A and 18B, in the case where a cooking element is participable by a second cook of “4 years old” or older or “5 years old” or older, the cooking element-participation degree is represented by a symbol “○.”

For example, as shown in FIG. 18B, the second cook of 4 years old cannot participate in a cooking element “Egg x Breaking” that corresponds to a cooking process “Break an egg in a bowl” included in the recipe “Tonpeiyaki.” In this case, the cooking element-participation degree corresponding to 4 years old is set to “0 (zero).”

The same cooking element “Egg x Breaking” is participable by the second cook of 5 years old. In this case, the cooking element-participation degree corresponding to 5 years old is set to “1 (one).”

Storage 12 stores the cooking elements that are participable by a second cook for each age. FIG. 19 shows cooking elements participable for each age. Storage 12 stores, in a table or the like, the cooking elements whose cooking element-participation degrees are “1 (one)” for a second cook of a specific age or older, such as “4 years old” and “5 years old.”

For example, as shown in FIG. 19, a second cook of “4 years old” or older can participate in cooking elements “Green vegetables x Tearing,” “Pouring sauce,” and “Dressing.” A second cook of “5 years old” or older can participate in cooking elements “Egg x Breaking” and “Root vegetables x Peeling” in addition to the cooking elements participable by the second cook of “4 years old” or older.

In the case where the number of cooking elements participable by second cooks is small, this method of storing allows a more efficient management of information regarding the cooking element-participation degrees.

The recipe-participation degree indicates the extent to which a second cook of a specific age can participate in the implementation of a specific recipe. The recipe-participation degree is calculated based on the cooking element-participation degree of a cooking element that corresponds to a cooking process included in the recipe.

In one example, in Step S300 described above, controller 16 calculates a ratio, to all of a recipe, of a cooking process corresponding to a cooking element participable by a second cook of a specific age, and then sets the thus-calculated ratio as the recipe-participation degree corresponding to the recipe.

For example, as shown in FIG. 18B, the recipe “Tonpeiyaki” includes eight cooking processes. The cooking element-participation degrees of the cooking elements “Green vegetables x Tearing” and “Pouring” for a second cook of “3 years old” or older are “1 (one).”

Therefore, in this recipe, the cooking processes corresponding to the cooking elements participable by a second cook of “3 years old” or older, are the second cooking process and eighth cooking process which correspond to the cooking elements “Green vegetables x Tearing” and “Pouring,” respectively.

The ratio of these cooking processes to all of the recipe is “2/8 (= 25%).” Controller 16 calculates this value as the recipe-participation degree of this recipe.

By the same calculation method and according to FIG. 18B, in the recipe “Tonpeiyaki,” the numbers of the cooking elements and cooking processes which are both participable by second cooks of “4 years old” and “5 years old” are 3 and 4, respectively. Therefore controller 16 calculates the values “⅜ (≒ 37.5%)” and “4/8 (= 50%)” as the recipe-participation degrees of the recipe “Tonpeiyaki” for “4 years old” and “5 years old,” respectively.

Controller 16 causes information presenter 14 to present the recipe-participation degree along with the recipe that corresponds to the recipe-participation degree, through use of a user interface, a chart, or the like. For example, the recipe-participation degree is presented numerically.

Controller 16 classifies the recipe-participation degrees into a plurality of participation-degree classes by using at least one participation-degree class threshold value and presents the recipe-participation degree by means of an appropriate one of the plurality of participation-degree classes. The plurality of participation-degree classes includes, for example, “Almost able to participate,” “Able to participate in about half,” and “Almost unable to participate.”

Controller 16 may present a plurality of recipe-participation degrees of a specific recipe for a plurality of ages, simultaneously, by means of a bar graph or the like.

In one example, a first cook designates a specific age via input part 18, and searches for recipes participable by a second cook of the designated age. Controller 16 collates recipes stored in storage 12 based on the designated age having been acquired via input part 18.

Controller 16 causes information presenter 14 to present a recipe, as proposed recipe 50, whose recipe-participation degree for the designated age is not lower than a participation-degree threshold value. The participation-degree threshold value is, for example, “0 (zero)%,” “20%,” or “50%.” The participation-degree threshold value may be designated by the first cook via input part 18.

FIG. 20 shows presented recipes and their recipe-participation degrees. As shown in FIG. 20, the first cook searches for recipes that are partially or totally participable by the second cook of the designated age (for example, “3 years old”). At that time, controller 16 causes searched recipes 20 to be presented as proposed recipes 50. Controller 16 also causes their recipe-participation degrees 34 to be presented.

In the example shown in FIG. 20, there are presented, as proposed recipes 50, recipes “Cabbage with Dressing,” “Tonpeiyaki,” “Yakisoba (original),” and “Yakisoba (for a 3-years-old child).” Their recipe-participation degrees 34 (“50%,” “25%,” “16%,” and “50%”) are also presented simultaneously.

Upon selection of any of proposed recipes 50 by the cook, information presenter 14 changes the screen shown in FIG. 20 to a screen (see FIG. 21) in which cooking processes included in proposed recipe 50 are presented.

Along with each of proposed recipes 50, a photograph and an illustration of a dish may be presented. Such photographs and illustrations of dishes help the cook easily image the dishes and are useful for the cook to select a recipe.

Upon clicking or pressing a photograph or illustration by the cook, information presenter 14 may display a larger-size photograph or illustration, a comment on the recipe, cooking processes included in the recipe, and the like. Information presenter 14 may change the screen shown in FIG. 20 to the screen shown in FIG. 21.

In one example, controller 16 causes information presenter 14 to present recipes whose recipe-participation degrees for the designated age are not lower than a participation-degree threshold value, in descending order of recipe-participation degree. For example, as shown in FIG. 20, controller 16 causes information presenter 14 to present the recipes “Cabbage with Dressing,” “Tonpeiyaki,” and “Yakisoba (original)” as proposed recipes 50. These recipes are arranged from the upper to the lower of the screen in descending order of recipe-participation.

Controller 16 causes proposed recipe 50 (for example, “Yakisoba [for a 3-years-old child]”) to be presented which has been changed for a second cook of a specific age, at a position under the original recipe, regardless of the recipe-participation degree after the change. In the case where there is a plurality of recipes having been changed, controller 16 may cause these changed recipes to be presented under the original recipe on the screen, such that they are arranged from the upper to the lower of the screen in descending order of targeted age.

In the present embodiment, the recipe-participation degree is presented, along with the recipe to the first cook, as a recipe reference level for determining the features of the recipe. The recipe-participation degree is calculated from the cooking element-participation degree of each cooking element included in the recipe.

The recipe-participation degree is a de*gree that indicates the extent to which the second cook of the specific age, when cooking together with the first cook, can participate in the implementation of a specific recipe. Therefore, the reference to the calculation is so concrete and accurate that the first cook can easily understand the recipe-participation degree and can be convinced of it.

In the present embodiment, the recipe-participation degree is provided along with proposed recipe 50. This allows the first cook to easily determine whether or not proposed recipes 50 are appropriate for the first cook’s self and the second cook, resulting in easy selection of a recipe to be implemented next. As long as the cooking element-participation degrees are common, the recipe-participation degrees (recipe reference levels) can be calculated according to a consistent reference.

### Eighth Exemplary Embodiment

Hereinafter, a cooking-learning support system and a cooking-learning support method, both according to an eighth exemplary embodiment of the present disclosure, will be described with reference to the drawings. With the cooking-learning support system and the cooking-learning support method, both according to the eighth exemplary embodiment, the cooking processes in a recipe having a recipe-participation degree not lower than “0 (zero)” are further presented.

In the case of the cooking processes being presented, controller 16 causes information presenter 14 to present the cooking processes in the recipe in a format emphasizing a cooking process participable by a second cook.

FIG. 21 shows cooking processes presented in a format emphasizing a cooking process participable by a second cook. For example, when the first cook selects proposed recipe 50 “Yakisoba (original)” shown in FIG. 20, controller 16 causes information presenter 14 to present cooking processes 22 in the recipe “Yakisoba (original)” as shown in FIG. 21.

A description of “original” will be made in the tenth embodiment. In the recipe “Yakisoba (original),” the second cook of “3 years old” can participate only in the cooking element “Pouring” corresponding to the cooking process “Pouring sauce.”

In order to attract the attention of both or one of the first and second cooks, a cooking process participable by the second cook is presented in various methods. The various methods in this case include highlighting, underlining, changing colors, marking, and the like.

In the present embodiment, the cooking processes are presented in a format in which the cooking process participable by the second cook is emphasized. Therefore, before the first cook implements the cooking process participable by the second cook, it is possible to attract the attention of the first cook. As a result, safety during the cooking can be enhanced.

### Ninth Exemplary Embodiment

Hereinafter, a cooking-learning support system and a cooking-learning support method, both according to a ninth exemplary embodiment of the present disclosure, will be described with reference to the drawings. With the cooking-learning support system and the cooking-learning support method, both according to the ninth exemplary embodiment, first support information or second support information is further presented which corresponds to a cooking element participable by a second cook.

In the ninth embodiment, storage 12 stores first support information or second support information corresponding to a participable cooking element. The first support information or second support information includes characters, images, voices, videos, and the like.

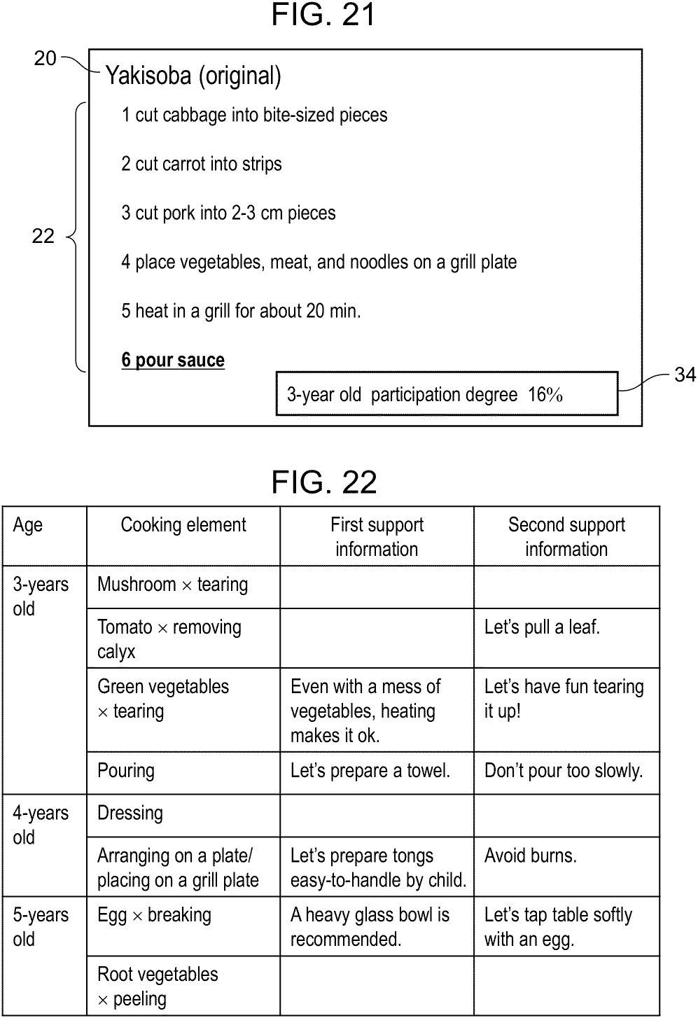

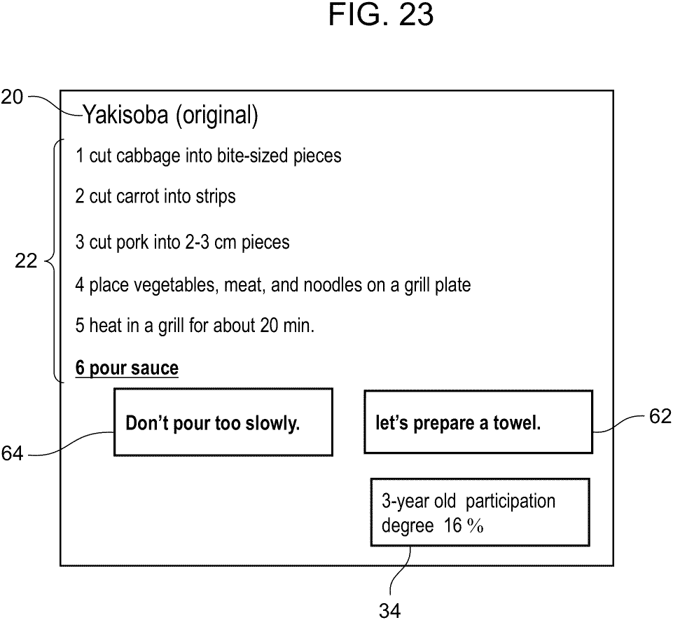

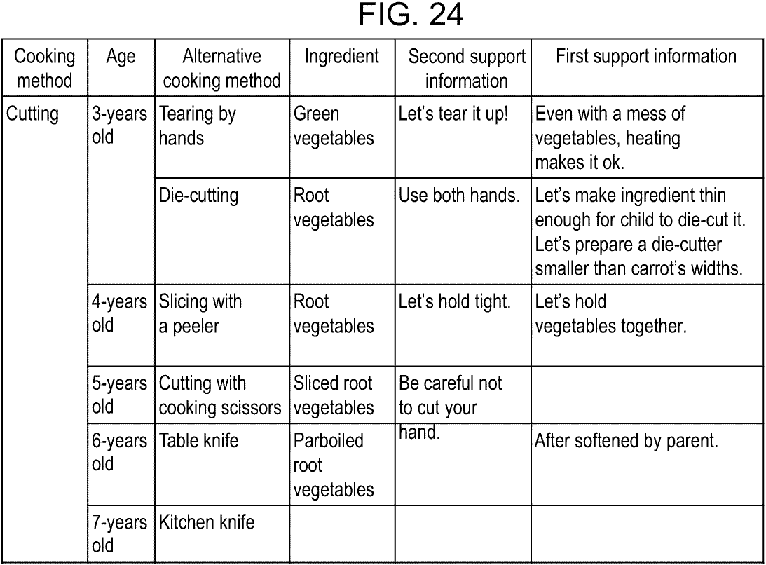

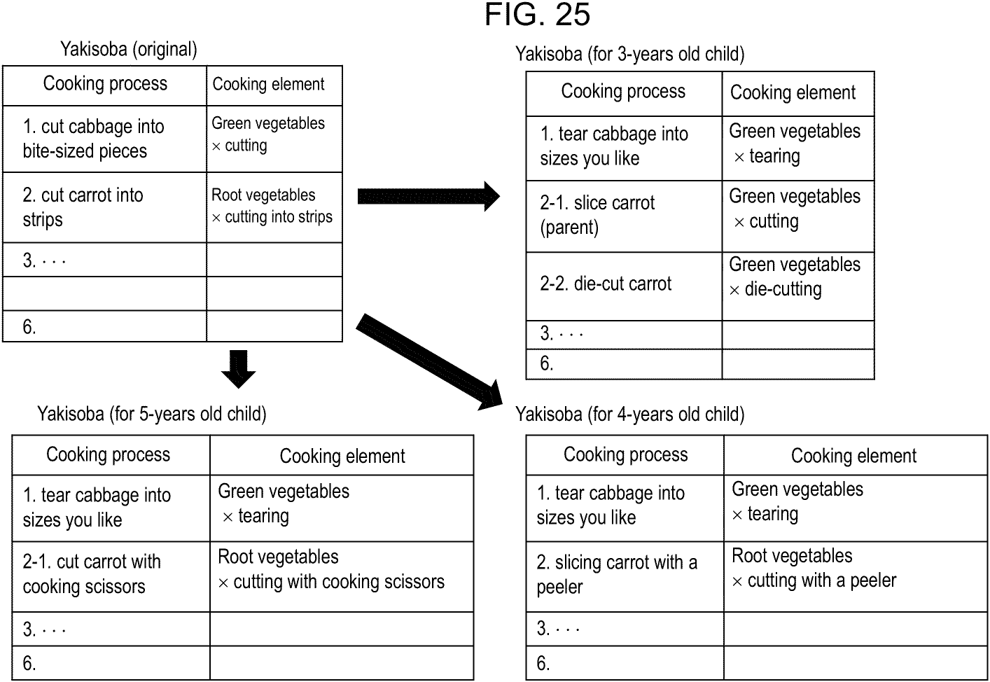

FIG. 22 shows support information. The first support information is information that is for a first cook and necessary in assisting the second cook. The first support information is either a description relating to the participation of the second cook or information relating to the preparation for letting the second cook participate, regarding a cooking element and a cooking process.

As shown in FIG. 22, for example, regarding the cooking element “green vegetables x tearing” participable by the second cook, the first support information is “Even with a mess of vegetables, heating makes it OK.” This is advice for the first cook in letting the second cook tear green vegetables.

There are cases where, for allowing the second cook to participate in the cooking, a cooking environment must be provided by preparations in advance by the first cook, such as by preparing required utensils and the like. The first support information may be information relating to such preparations.

For example, for the cooking element “Pouring” participable by the second cook, the first support information is “Let’s prepare a towel.” This is advice regarding the preparation for allowing the second cook to pour dressing or the like on a dish.

The second support information is information for the second cook. The second support information is information regarding the cooking elements and cooking processes, the information which is expressed by words suitable for the specific age of the second cook.

In the case where the second cook is a preschool child or a child of lower or middle grades of elementary school, it is difficult for such a child to fully understand the description of a cooking process. For this reason, the second cook is likely to be unable to implement the cooking process smoothly.

In order to support the understanding and cooking by the second cook, the second support information provides the content of a cooking process, precautions, supplementary information, or the like, by means of words, terms and wording suitable for the age of the second cook.

For example, the second support information is “Let’s have fun tearing it up!” This is advice for helping the second cook of “3 years old” understand the cooking element “Green vegetables x Tearing.” For the same cooking element, different second support information may be presented to different second cooks of different ages.

Controller 16 may cause the first support information or second support information described above to be presented along with the cooking processes. Specifically, controller 16 may read, from storage 12, cooking processes and either first support information or second support information that corresponds to at least one cooking process, and may cause information presenter 14 to present the information.

FIG. 23 shows a presentation of support information. As shown in FIG. 23, controller 16 causes recipe 20 and its recipe-participation degree 34, cooking processes 22, and first support information 62 and second support information 64 to be presented.

First support information 62 and second support information 64 are arranged near the cooking process on the screen, for easy understanding of their relationship with the cooking process “Pouring sauce.” In the case where first support information 62 and second support information 64 are presented simultaneously, which both correspond to the same cooking element and cooking process, controller 16 may cause first support information 62 and second support information 64 to be presented side by side.

In one example, the first support information and the second support information may be presented on a screen separate from the screen on which the recipe and the recipe-participation degree are presented, and may be presented on a screen separate from the screen on which the cooking process is presented.

For example, when the first cook selects one of a plurality of recipes 20 and their recipe-participation degrees 34 shown in FIG. 20, cooking processes 22 shown in FIG. 21 are presented.

When the first cook clicks or presses the cooking process “Pouring sauce” that is emphasized and presented, the next information is presented on another screen, a divided screen, a pop-up screen, or the like. The next information is the first support information “Let’s prepare a towel” and the second support information “Don’t pour too slowly” which both are relating to the cooking process “Pouring sauce.”

In one example, storage 12 stores other support information different from the first support information and second support information. Controller 16 reads such other support information from storage 12 and causes information presenter 14 to present the thus-read information along with the cooking process. Such other support information includes characters, images, voices, videos, and the like.

For example, for the cooking element “Green vegetables x Tearing,” other support information is a photograph or illustration of a scene of tearing cabbage. For the cooking element “Egg x Breaking,” other support information is a photograph or illustration of a scene of tapping a countertop with an egg. Such other support information allows the second cook to better understand the second support information.

In the ninth embodiment, for the cooking process participable by the second cook, the first support information for the first cook or the second support information for the second cook may be further presented.

From the first support information, the first cook can know the preparations to be done in advance or the precautions to be taken in the cooking process. Therefore, the cooking is likely to be implemented smoothly. The second support information is expressed by wording suitable for the age of the second cook. Therefore, the second support information is more easily understood by the second cook than a general explanation.

### Tenth Exemplary Embodiment

Hereinafter, a cooking-learning support system and a cooking-learning support method, both according to a tenth exemplary embodiment of the present disclosure, will be described with reference to the drawings. With the cooking-learning support system and the cooking-learning support method, both according to the tenth exemplary embodiment, a designated cooking method in a cooking element and cooking process may be changed to an alternative cooking method for a specific age.

In the tenth embodiment, storage 12 stores at least one cooking method as a designated cooking method, and stores an alternative cooking method to the designated cooking method for each specific age.

In one example, storage 12 stores, as a designated cooking method, a cooking method that is difficult to implement or should be avoided for a second cook of a specific age. For example, the cooking method “Cutting with a kitchen knife” is generally difficult for a little child to implement, and so should be avoided. Therefore, this cooking method is a designated cooking method for second cooks of younger than 7 years old.

The alternative cooking method is a cooking method that can be an alternative to the designated cooking method and that is a more simple and safer cooking method than the designated cooking method. In the case where the same designated cooking method is combined with different ingredients, different alternative cooking methods are set for different ingredients to be combined. That is, depending on either the applied age or the ingredient to be combined, different alternative cooking methods are set to the same designated cooking method.

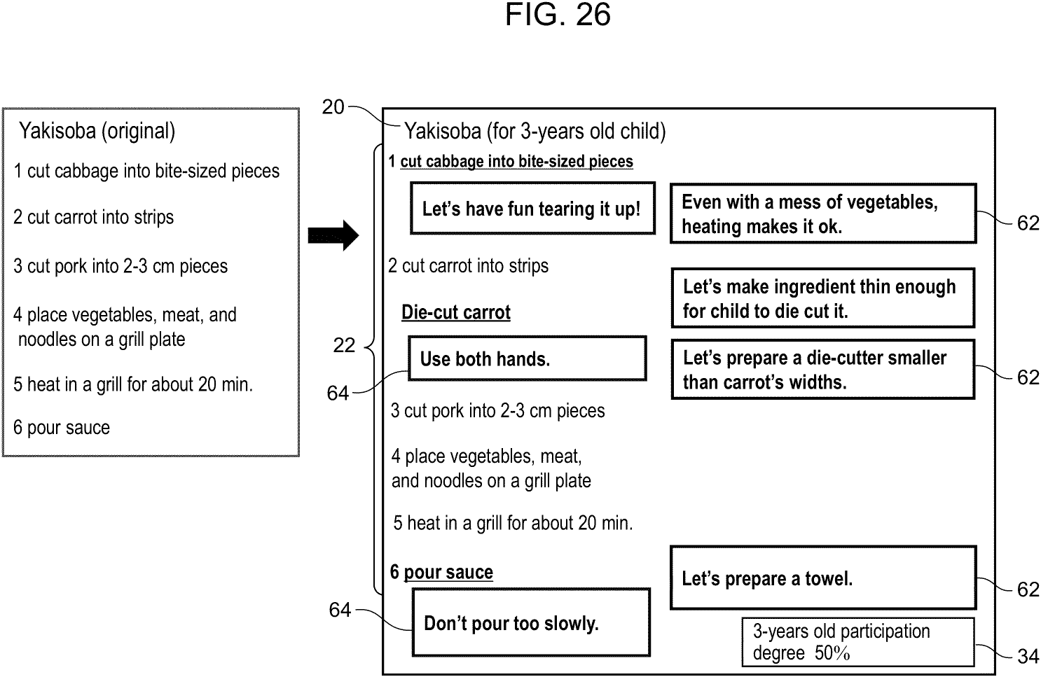

FIG. 24 shows alternative cooking methods. In the example shown in FIG. 24, in the case where the cooking method “Cutting” is combined with an ingredient “Green vegetables,” the alternative cooking method is “Tearing with hands” for a second cook of “3 years old.” In the case where the cooking method “Cutting” is combined with an ingredient “Root vegetables,” the alternative cooking method is “Die-cutting.”

In the case where the cooking method “Cutting” is combined with an ingredient “Root vegetables,” the alternative cooking method is “Die-cutting” for a second cook of “3 years old,” and “Slicing with a peeler” for a second cook of “4 years old.”

For each of these alternative cooking methods, both or one of the first support information and the second support information may be set. In the case where different alternative cooking methods are set, different pieces of first support information or different pieces of second support information may be set for different alternative cooking methods.

In this case, the first support information or second support information is set based on the alternative cooking method. For example, as shown in FIG. 24, for the designated cooking method “Cutting,” storage 12 stores the following first support information and second support information along with the alternative cooking method “Die-cutting.”

The first support information is “Make the ingredient thin for easy die-cutting by a child” and “Prepare a die-cutter smaller than carrot’s widths,” before allowing the second cook to implement die-cutting. The second support information is “Use both your hands” for the die-cutting by the second cook.

Storage 12 stores, for each applied age and to-be-combined ingredient, an alternative cooking method, and related first support information and related second support information.

By changing a designated cooking method to an alternative cooking method for a specific age, the original cooking element is set to a cooking element for the specific age. For example, for a second cook of “3 years old,” the cooking element “Green vegetables x cutting” is changed to a cooking element “Green vegetables x tearing.”

For a cooking element having a designated cooking method, controller 16 causes an alternative cooking method to be presented instead of the designated cooking method. Controller 16 causes the cooking element, cooking process, and recipe to be presented which have been changed using the alternative cooking method, in place of the original cooking element, cooking process, and recipe.

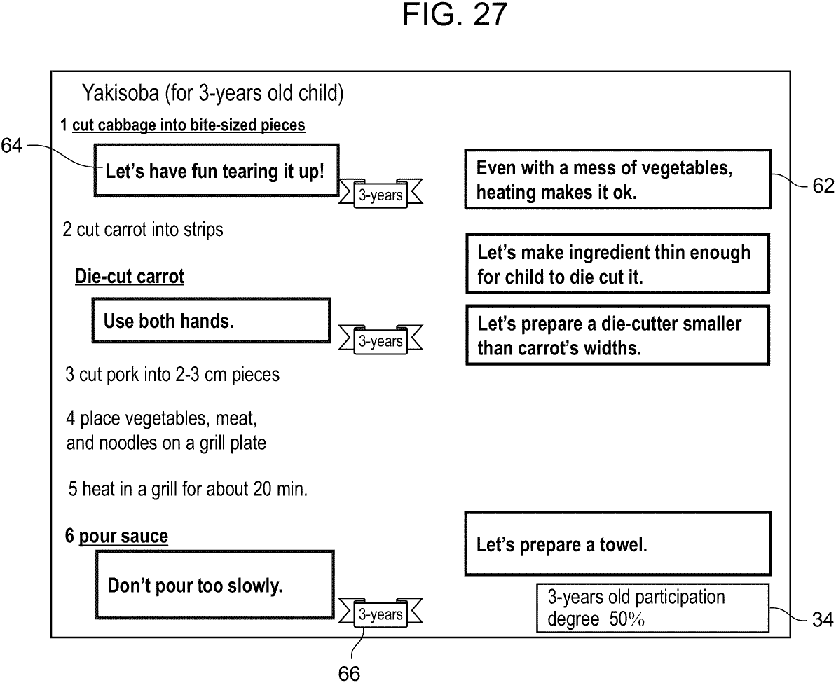

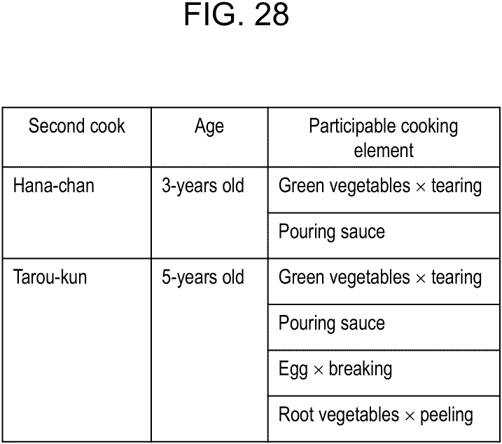

FIG. 25 shows cooking elements and cooking processes, both of which have been changed using alternative cooking methods. FIG. 26 shows presentation of the cooking processes and support information of a recipe “Yakisoba,” the processes and information which have been changed using alternative cooking methods.

The original recipe “Yakisoba” includes the cooking process corresponding to the cooking element “Green vegetables x Cutting.” As shown in FIG. 25, controller 16 changes the cooking element, cooking process, and recipe, for each of second cooks of “3 years old,” “4 years old,” and “5 years old,” using the Table of FIG. 24.

For example, the cooking process “Cutting a carrot into strips” corresponding to the same “Root vegetables x Cutting into strips” is changed to a cooking process “Slicing a carrot (parent)/Die-cutting a carrot” in the recipe for “3 years old.” This cooking process is changed to a cooking process “Slicing a carrot with a peeler” in the recipe for “4 years old.” This cooking process is changed to a cooking process “Cutting a carrot with cooking scissors” in the recipe for “5 years old.”

Controller 16 causes information presenter 14 to present the thus-changed recipe as a recipe “Yakisoba” for “3 years old,” “4 years old,” or “5 years old.”

There are cases where the use of an alternative cooking method causes an original cooking element which is not participable by a second cook of a specific age to be changed to a cooking element participable by the second cook. Controller 16 causes the thus-changed cooking process to be present in an emphasized format. Controller 16 causes information presenter 14 to present first support information and second support information which correspond to the thus-changed cooking process.

In the case where an alternative cooking method allows a second cook of a specific age to be able to participate, controller 16 may recalculate the recipe-participation degree for the specific age. An increase in the number of cooking processes participable by the second cook of the specific age, increases the recipe-participation degree of the changed recipe to higher than the recipe-participation degree of the original recipe.

For example, as shown in FIG. 23, in the original recipe “Yakisoba,” the cooking process participable by a second cook of “3 years old” is only “Pouring sauce.” Therefore, recipe-participation degree 34 for “3 years old” is “⅙ (≒ 16%).”

As shown in FIG. 26, in the recipe “Yakisoba” having been changed as described above, the cooking process participable by a second cook of “3 years old” includes “Tearing cabbage into sizes you like,” “Die-cutting a carrot,” and “Pouring sauce.” Therefore, recipe-participation degree 34 for “3 years old” is “3/6 (= 50%).”

When presenting a recipe including a cooking element having an alternative cooking method or calculating the recipe-participation degree of such a recipe, controller 16 may perform, in real time, the changing by using the alternative cooking method. Controller 16 may perform the changing in advance, and cause storage 12 to store the thus-changed cooking element and recipe-participation degree thereof, separately from the original cooking element and recipe-participation degree thereof, in which case controller 16 may read the stored information from storage 12 as appropriate.

In the tenth embodiment, the designated cooking method which is difficult to implement or should be avoided for a second cook of a specific age, is changed to an alternative cooking method for the specific age. This allows the second cook to easily participate in the cooking and to more safely implement the cooking.

### Eleventh Exemplary Embodiment

Hereinafter, a cooking-learning support system and a cooking-learning support method, both according to an eleventh exemplary embodiment of the present disclosure, will be described with reference to the drawings. With the cooking-learning support system and the cooking-learning support method, both according to the eleventh exemplary embodiment, the age corresponding to support information is presented by visual presentation.

Along with a cooking process and first or second support information, controller 16 causes information to be presented which expresses the age corresponding to the first or second support information. The information includes at least one of a character, numeral, symbol, picture, figure, crest, pattern, and form.

The first support information or the second support information, or the changed cooking process corresponds to a specific age. In the embodiment, in order for a first cook to easily understand the age, controller 16 causes the age to be presented by using characters, symbols, or figures.

FIG. 27 shows presentation of an age corresponding to support information. In FIG. 27, there is presented a recipe “Yakisoba” that has been changed for a second cook of “3 years old.” In FIG. 27, the changed cooking processes, first support information 62, and second support information 64 are also presented.

Further, presented marks 66 express that the age corresponding to these changes and support information is “3 years old.” As described above, each of marks 66 includes at least one of a character, numeral, symbol, picture, figure, crest, pattern and form which expresses the specific age. In the example shown in FIG. 27, mark 66 is a combination of a character, numeral, and figure.

In the eleventh embodiment, the following information regarding the specific age is clearly presented by the presentation method described above. The information is which age the cooking process has been changed for, which cooking process the second cook can participate in, and which age the first or second support information relates to.

### Twelfth Exemplary Embodiment

Hereinafter, a cooking-learning support system and a cooking-learning support method, both according to a twelfth exemplary embodiment of the present disclosure, will be described with reference to the drawings. With the cooking-learning support system and the cooking-learning support method, both according to the twelfth exemplary embodiment, information on a specific second cook is stored via inputting and the like by a first cook.

In the cooking-learning support system and the cooking-learning support method, the unique participation degree, which indicates the extent to which the specific second cook can participate, is defined as the cooking element-participation degree. The recipe-participation degree is calculated based on the unique participation degree.

In one example, the first cook inputs information such as the name and age of the specific second cook to the cooking-learning support system via input part 18. Storage 12 stores the inputted information on the second cook.

The name of the specific second cook involves how to call the second cook, that is, the name, nickname, abbreviation, etc. of the second cook. The name for calling the specific second cook includes, for example, “Tarou-kun” and “Hana-chan.”

Further, storage 12 stores the unique participation degree, which indicates the extent to which the specific second cook can participate in the cooking element, as the cooking element-participation degree. The unique participation degree is the cooking element-participation degree exclusively used for the specific second cook.

Generally, the stored cooking element-participation degree cannot be changed except for a specially set degree and the like. However, since the unique participation degree relates to only the possibility of a specific second cook being able to participate in cooking, it can be changed as will be described later in the thirteenth embodiment.

Storage 12 stores the unique participation degrees for a plurality of specific second cooks. FIG. 28 shows cooking elements participable by specific second cooks. As shown in FIG. 28, storage 12 displays cooking elements participable for each of the plurality of specific second cooks. Storage 12 may store first support information and second support information which correspond to the cooking elements.

In one example, as the learning levels in the example (fourth exemplary embodiment) shown in FIGS. 15A or 15B, storage 12 stores the unique participation degree for each cooking date or number of cooking times. Controller 16 causes information presenter 14 to present the unique participation degree for each cooking date or number of cooking times.

In one example, the default value of the unique participation degree is the cooking element-participation degree for a specific age of a second cook. For example, in the case where the age of the specific second cook “Tarou-kun” is “5 years old,” controller 16 causes storage 12 to store the “Cooking element participable by a second cook of ‘5 years old,’” which has been already stored in storage 12, as an initial value of the “Cooking element participable by ‘Tarou-kun.’”

That is, when “Tarou-kun” is registered at the cooking-learning support system for the first time, the cooking element-participation degree corresponding to “Tarou-kun” is stored in the same manner as the cooking element-participation degree corresponding to “5 years old.”

With the cooking-learning support system and the cooking-learning support method, since the unique participation degree is treated as the cooking element-participation degree, the recipe-participation degree is calculated based on the unique participation degree. Hereinafter, an example will be described in which the recipe-participation degree of a recipe for a specific second cook is to be calculated.

Controller 16 reads, from storage 12, the unique participation degree for the specific second cook, instead of the cooking element-participation degree, based on the age of the specific second cook. Based on the unique participation degree, controller 16 calculates a ratio of the cooking process corresponding to the cooking element participable by the second cook to all of the recipe, as the recipe-participation degree.

In one example, a first cook designates a specific second cook via input part 18, and searches for recipes participable by the second cook. Controller 16 causes the information presenter to present, as proposed recipes 50, recipes having the recipe-participation degrees for the designated specific second cook, with the recipe-participation degrees being not lower than a participation-degree threshold value.

Upon acquiring the input regarding the specific second cook via input part 18, controller 16 collates recipes stored in storage 12 based on the input. Controller 16 causes information presenter 14 to present, as proposed recipes 50, recipes having the recipe-participation degrees that have been calculated from the unique participation degrees corresponding to the specific second cook, with the recipe-participation degrees being not lower than a participation-degree threshold value.

The participation-degree threshold value is, for example, “0 (zero)%,” “20%,” or “50%.” The participation-degree threshold value is designated by the first cook via input part 18.

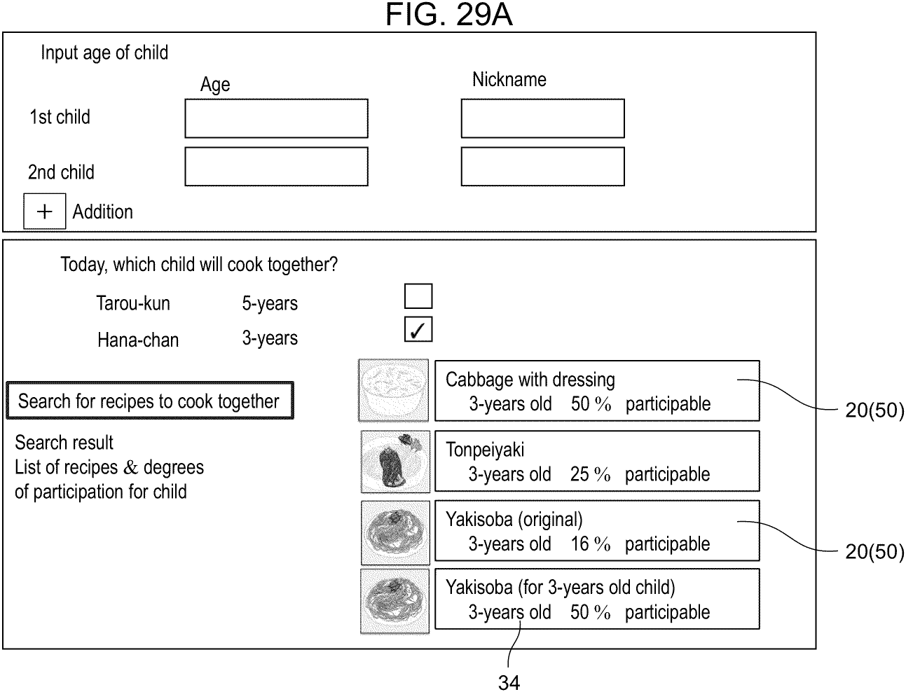

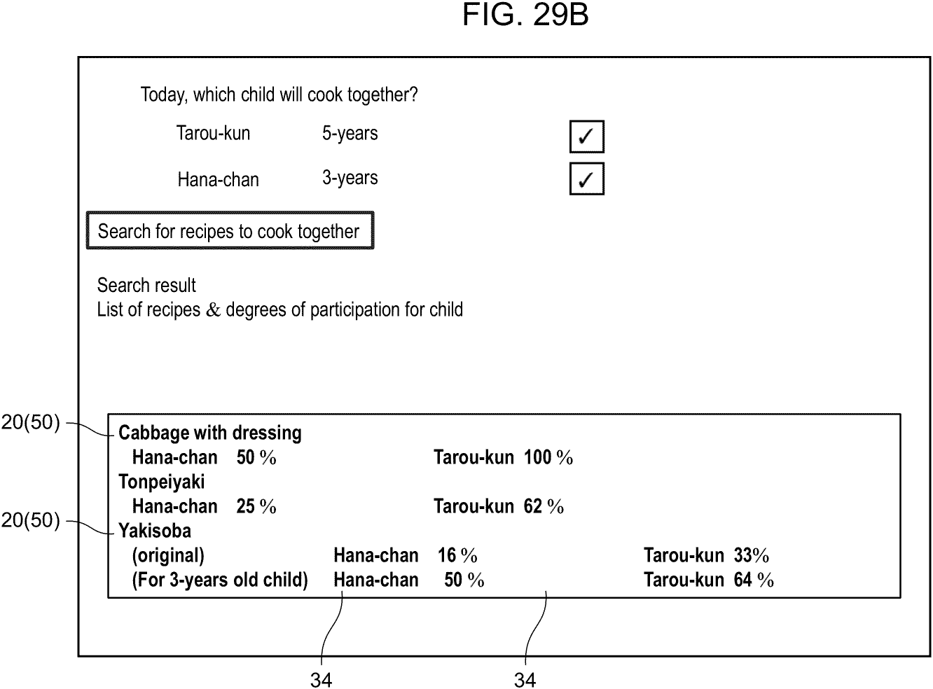

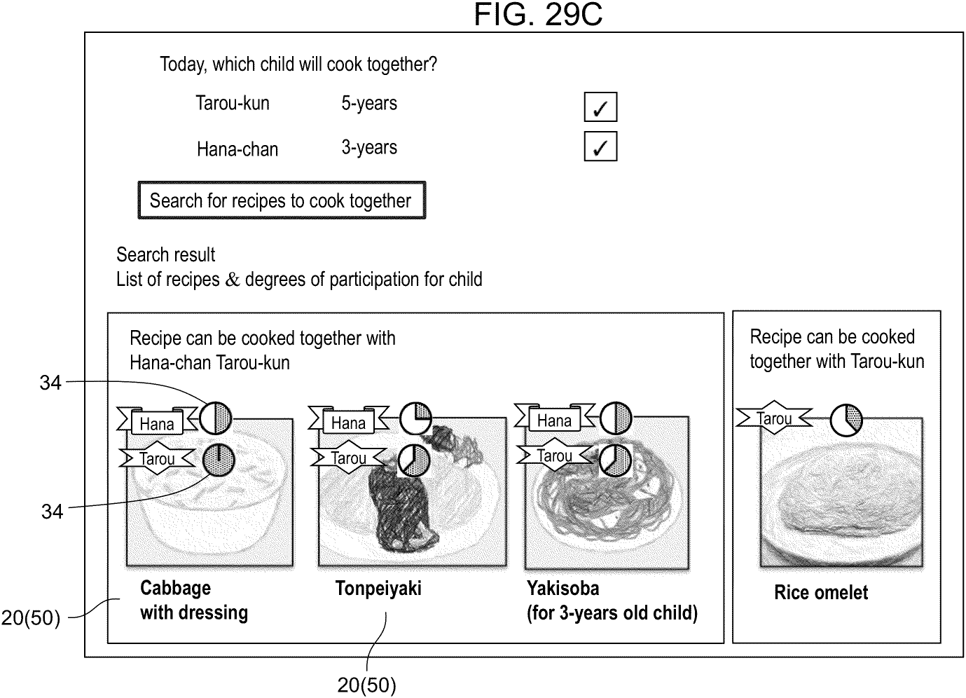

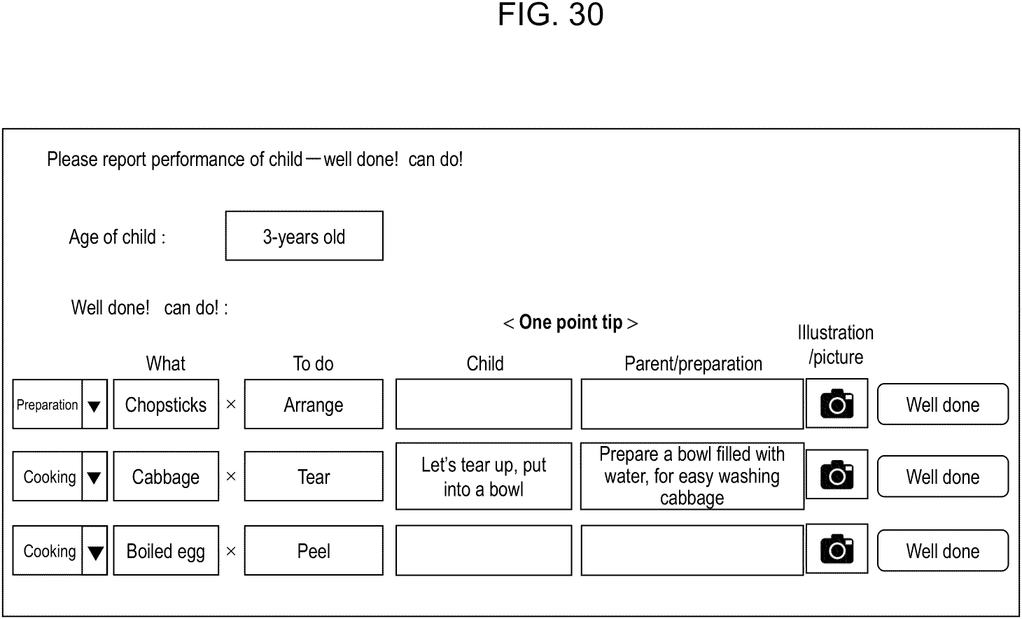

FIG. 29A shows the recipes and recipe-participation degrees thereof which are presented for a specific second cook. Through the user interface at the upper part of the screen shown in FIG. 29A, the first cook registers the name and age of the specific second cook at the cooking-learning support system.

For a second cook who has already been registered, recipes participable by the second cook are searched via the user interface at the upper part of the screen shown in FIG. 29A. For example, the cooking-learning support system presents a list of the names and ages of the registered specific second cooks and an input means operable by the first cook. The input means is, for example, check boxes shown in FIG. 29A.

When the first cook uses the check box to designate a person to participate in cooking from the second cooks being presented, controller 16 receives the designation via input part 18. Controller 16 causes information presenter 14 to present the search result, that is, recipes 20 (i.e., proposed recipes 50) and recipe-participation degrees 34 thereof.

FIG. 29A shows the search result about the specific second cook “Hana-chan” of “3 years old.” For example, for the specific second cook “Hana-chan,” the recipe-participation degree of the recipe “Cabbage with Dressing” is “50%.” The recipe-participation degree of the recipe “Tonpeiyaki” is “25%.”

For each of proposed recipes 50, a photograph or illustration of a dish may be presented. Such photographs or illustrations of dishes help the cook easily image dishes and select a recipe.

Upon clicking or pressing a photograph or illustration by the cook, controller 16 may make the presentation of a larger-size photograph or illustration, a comment on the recipe, cooking processes included in the recipe, or the like. Controller 16 may make the presentation of cooking processes included in the recipe.

FIG. 29B shows the recipes and recipe-participation degrees thereof which are presented for specific second cooks. Controller 16 acquires the designation of a plurality of specific second cooks via input part 18. Controller 16 causes information presenter 14 to simultaneously present at least one recipe and a plurality of recipe-participation degrees of the at least one recipe, with the plurality of recipe-participation degrees corresponding to the plurality of specific second cooks.

In the example shown in FIG. 29B, the presented second cooks “Tarou-kun” and “Hana-chan” are designated. Therefore, information presenter 14 causes information presenter 14 to present the search result, that is, recipes 20 (i.e., proposed recipes 50) and the recipe-participation degrees thereof corresponding to each of “Tarou-kun” and “Hana-chan.”

In one example, when the recipe-participation degree corresponding to at least one of the specific second cooks is not lower than a participation-degree threshold value, controller 16 causes information presenter 14 to present the corresponding recipe and recipe-participation degree therefor.

In one example, controller 16 causes the recipe-participation degree to be presented not by numerals or characters but by a diagram, graph, or the like. FIG. 29C shows the recipes and recipe-participation degrees thereof which are presented for the specific second cooks.

In the example shown in FIG. 29C, each of recipe-participation degrees 34 is expressed, in a pie chart, as a ratio of a shaded area to the entire pie. Specifically, the ratios of the respective shaded areas to the respective entire pies are 25%, 33%, 50%, 62%, and 100%.

In the twelfth embodiment, information on a specific second cook is registered through the input or the like by a first cook. The recipe-participation degree is calculated based on the unique participation degree for the specific second cook. This allows the first cook to easily understand the meaning of the recipe-participation degree, resulting in easy selection of a recipe to be implemented next.

### Thirteenth Exemplary Embodiment

Hereinafter, a cooking-learning support system and a cooking-learning support method, both according to a thirteenth exemplary embodiment of the present disclosure, will be described with reference to the drawings.

With the cooking-learning support system and the cooking-learning support method, both according to the thirteenth exemplary embodiment, the unique participation degree is set based on the input by a first cook. Upon receiving a unique participation degree-setting command for instructing to set the unique participation degree of at least one cooking element via input part 18, controller 16 set the unique participation degree of the at least one cooking element.

In the present embodiment, the cooking-learning support system presents a user interface for acquiring feedback on the finished quality of at least one cooking element after the cooking, for example. Controller 16 uses the feedback as a unique participation degree-setting command, and either sets a new unique participation degree or changes the already-stored unique participation degree, based on the unique participation degree-setting command.

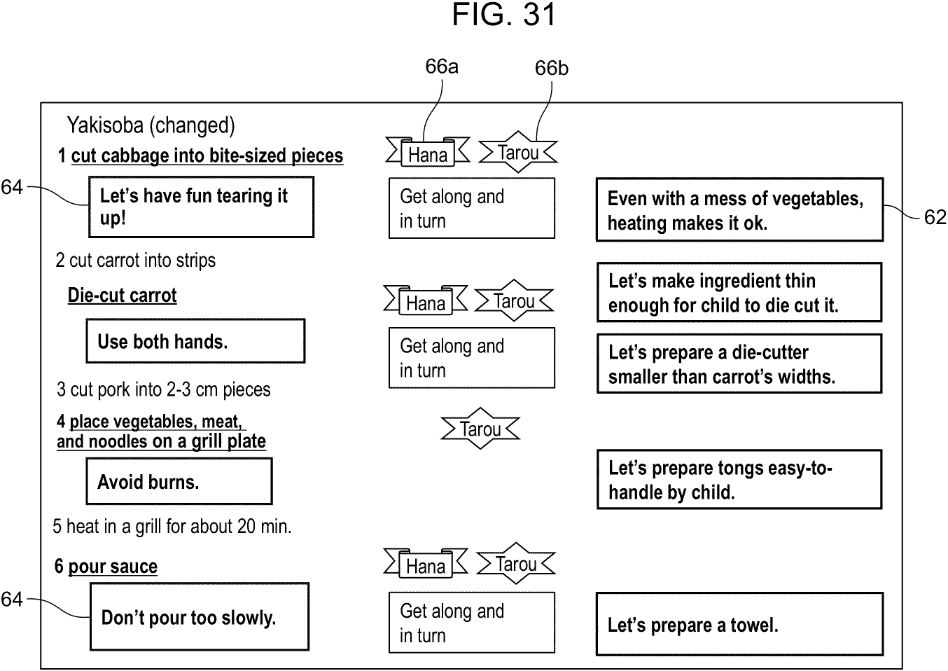

FIG. 30 shows one example of a user interface for inputting a unique participation degree-setting command. In the example shown in FIG. 30, the first cook designates the age of a second cook and a cooking element that are included in the recipe having been implemented, via drop-down lists (drop-down list) or text boxes (text box).

Next, regarding the designated cooking element, the first cook inputs whether or not the second cook implemented it successfully. For example, when the second cook was able to implement the cooking element “Cabbage x Tearing,” the first cook presses the button “Well done,” thereby inputting feedback (unique participation degree-setting command).

In response to the feedback (unique participation degree-setting command), controller 16 sets the unique participation degree of the cooking element “Cabbage x Tearing” for the second cook equal to “1 (one).” Controller 16 sets a unique participation degree each time it receives a unique participation degree-setting command.

In a plurality of cooking times, controller 16 sets a unique participation degree when it receives the same unique participation degree-setting command for the same second cook and cooking element a predetermined number of times (e.g., three times). That is, when the second cook successfully implemented the same cooking element multiple times, controller 16 sets the unique participation degree.

In one example, as in the case of the learning levels in the fourth embodiment, controller 16 accumulates the number of cooking times for the same cooking element, and then automatically changes the unique participation degree according to the accumulated number of the cooking times.

In order for the first or second cook to easily image at least one cooking element, controller 16 causes a photograph or illustration expressing the cooking element to be presented in a column “illustration/photograph.”

Controller 16 causes information presenter 14 to present, for example, a photograph or illustration of a scene of tearing cabbage or a photograph or illustration of a scene of peeling an egg.

The screen of information presenter 14 is unable to display so much information simultaneously. Therefore, controller 16 causes icons or marks to be presented in the column “illustration/photograph” and, upon clicking or pressing an icon or mark, controller 16 may cause a larger-size photograph or illustration to be further presented.

In the thirteenth embodiment, the unique participation degree corresponding to a specific second cook can be automatically updated based on the number of cooking times or the like and can be manually set by a first cook. Thus, the unique participation degree and recipe-participation degree calculated based on the unique participation degree, can reflect the progress of the cooking skill of the specific second cook, and so they are highly reliable. Therefore, the recipe-participation degree agrees with the feeling of the first cook.

### Fourteenth Exemplary Embodiment

Hereinafter, a cooking-learning support system and a cooking-learning support method, both according to a fourteenth exemplary embodiment of the present disclosure, will be described with reference to the drawings. In the cooking-learning support system and the cooking-learning support method, both according to the fourteenth exemplary embodiment, the name or age of a designated specific second cook is presented by a visual presentation.

In the fourteenth embodiment, controller 16 causes information to be presented that indicates the name or age of the designated specific second cook, along with cooking processes and first or second support information. The information includes at least one of a character, numeral, symbol, picture, figure, crest, pattern, and form.

The first or second support information or the cooking processes having been changed, corresponds to the specific second cook. In the embodiment, controller 16 causes the name or age of the second cook to be presented by using a character, symbol, figure, etc. This allows the first cook to easily recognize the corresponding second cook.

In the case of a plurality of second cooks being designated, controller 16 causes their ages to be presented by using characters, symbols, figures, etc. This allows the first cook to easily understand which cooking process or support information corresponds to which second cook.

FIG. 31 shows the presentation of the names of specific second cooks, with the manes corresponding to support information for the specific second cooks. Marks 66a and 66b correspond to the specific second cooks “Hana-chan” and “Tarou-kun,” respectively. Marks 66a and 66b clearly present which second cook can participate in the changed cooking process. Marks 66a and 66b also clearly present to which second cook the support information (especially, second support information) relates.

For example, as shown in FIG. 31, the changed cooking process “Tearing cabbage into sizes you like” is labeled with marks 66a and 66b. Therefore, it is possible to understand that the second cooks “Hana-chan” and “Tarou-kun” can participate in it.

The cooking process “Putting vegetables, meat, and noodles on a grilled-dish plate” is labeled only with mark 66b. This makes it possible to understand that only the second cook “Tarou-kun” of “5 years old” can participate in it.

As described above, marks 66a and 66b corresponding to the specific second cooks each include at least one of a character, numeral, symbol, picture, figure, crest, pattern, and form. Marks 66a and 66b represent the names or ages of these second cooks. In the example shown in FIG. 31, marks 66a and 66b are each a combination of characters and a figure.

The presentation method described above relating to specific second cooks clearly presents for which specific second cook the cooking process has been changed. This presentation method also clearly presents in which cooking process the second cook can participate and to which specific second cook the first or second support information relates.

### Advantageous Effects

In the cooking-learning support system and cooking-learning support method according to the present disclosure, for a cooking element, the cooking element-difficulty degree or the cooking-element reference level, i.e., the cooking element-participation degree is stored. The cooking element is an ingredient, a cooking method for the ingredient, or a combination of the ingredient and the cooking method.

A recipe reference level is calculated according to the cooking-element reference level, and is presented to a first cook. Therefore, it is possible to accurately calculate the recipe reference level. The calculated recipe reference level easily convinces the cook, and is useful for the cook to select a recipe appropriate for the cook’s self.

### INDUSTRIAL APPLICABILITY

As described above, the cooking-learning support system and the cooking-learning support method, both according to the present disclosure, are applicable to heating cookers.

### REFERENCE MARKS IN THE DRAWINGS

| | |
|---|---|
| 10 | cooking-learning support system |
| 12 | storage |
| 14 | information presenter |
| 16 | controller |
| 18 | input part |
| 20 | recipe |
| 22 | cooking process |
| 30 | recipe reference level |
| 32 | recipe-difficulty degree |
| 34 | recipe-participation degree |
| 40 | supplementary information |
| 50 | proposed recipe |
| 62 | first support information |
| 64 | second support information |
| 66, 66a, 66b | mark |

1. A cooking-learning support system, comprising:
a storage;
an information presenter; and
a controller,
wherein the storage is configured to store
at least one recipe including at least one cooking process,
at least one cooking element being one of
at least one ingredient for cooking,
at least one cooking method for the at least one ingredient, and
a combination of the at least one ingredient and the at least one cooking method, and
a cooking-element reference level of the at least one cooking element,
wherein the information presenter is operable to present the at least one recipe, and
wherein the controller is operable to
calculate a recipe reference level corresponding to the at least one recipe, based on the cooking-element reference level of the at least one cooking element corresponding to the at least one cooking process in the at least one recipe, and
cause the information presenter to present the at least one recipe and the recipe reference level calculated.

2. The cooking-learning support system according to claim 1,
wherein the cooking-element reference level is at least one cooking-element difficulty degree of the at least one cooking element, and
wherein the recipe reference level is a recipe-difficulty degree of the at least one recipe.

3. The cooking-learning support system according to claim 2,
wherein the controller is operable to
set the at least one cooking element in the at least one recipe as an item of a chart, and
cause the information presenter to present the recipe-difficulty degree in the chart by causing the information presenter to present the at least one cooking element-difficulty degree degree corresponding to each of items each being the item.

4. The cooking-learning support system according to claim 3,
wherein the at least one ingredient comprises a plurality of ingredients, and the at least one cooking process comprises a plurality of cooking processes, and
wherein the controller is operable to set, as the item of the chart, one of
a number of characters written in the at least one recipe,
a number of the cooking processes in the at least one recipe,
a number of the ingredients for use in the at least one recipe, and
required cooking time in the at least one recipe.

5. The cooking-learning support system according to claim 2,
wherein the controller is operable to
classify the recipe-difficulty degree into a plurality of difficulty-degree classes based on at least one difficulty-degree classification threshold value, and
cause the information presenter to present the plurality of difficulty-degree classes along with both the at least one recipe and the recipe-difficulty degree.

6. The cooking-learning support system according to claim 2,
wherein the at least one cooking element-difficulty degree comprises a plurality of cooking element-difficulty degrees, the at least one cooking element comprises a plurality of cooking elements, and the at least one cooking process comprises a plurality of cooking processes, the cooking element-difficulty degrees of the cooking elements corresponding to the cooking processes in the at least one recipe, and
wherein the controller is operable to
calculate one of
a sum total of the cooking element-difficulty degrees,
a maximum value of the cooking element-difficulty degrees, and
an average value of the cooking element-difficulty degrees, and
set the one of
the sum total,
the maximum value, and
the average value as the at least one recipe-difficulty degree corresponding to the at least one recipe.

7. The cooking-learning support system according to claim 2,
wherein the storage is configured to store supplementary information corresponding to the at least one recipe, the supplementary information being information that relates to either the at least one ingredient in the at least one recipe or the at least one cooking method and that relates to the recipe-difficulty degree of the at least one recipe, and
wherein, for a presented recipe being the at least one recipe having the recipe-difficulty degree that is either not lower than a first difficulty-degree threshold value or not higher than a second difficulty-degree threshold value lower than the first difficulty-degree threshold value, the controller is operable to cause the information presenter to present the supplementary information along with both the presented recipe and the recipe-difficulty degree.

8. The cooking-learning support system according to claim 7,
wherein, in a case where the recipe-difficulty degree of the presented recipe is not lower than the first difficulty-degree threshold value, the supplementary information indicates that the presented recipe includes the at least one cooking process corresponding to the at least one cooking element-difficulty degree not lower than a third difficulty-degree threshold value, and
wherein, in a case where the recipe-difficulty degree of the presented recipe is not higher than the second difficulty-degree threshold value, the supplementary information indicates that the presented recipe does not include the at least one cooking process corresponding to the at least one cooking element-difficulty degree not higher than a fourth difficulty-degree threshold value.

9. The cooking-learning support system according to claim 7,
wherein the storage is configured to store a recipe group including the at least one recipe, the presented recipe being included in the recipe group, and
wherein, in a case where the recipe-difficulty degree of the presented recipe is not higher than the second difficulty-degree threshold value, the supplementary information indicates either that the presented recipe does not include a designated ingredient included in a predetermined number of other recipes included in the recipe group or that the presented recipe includes one of a substitute cooking method and a substitute ingredient.

10. The cooking-learning support system according to claim 2,
wherein the storage is configured to store a learning level of a first cook for the at least one cooking element, and
wherein the controller is operable to cause the information presenter to present the learning level along with both a presented recipe and the recipe-difficulty degree.

11. The cooking-learning support system according to claim 10,
wherein the storage is configured to store the learning level for each either a cooking date or a number of cooking times, and
wherein the controller is configured to cause the information presenter to present the learning level for each either the cooking date or the number of cooking times.

12. The cooking-learning support system according to claim 10,
wherein the learning level for the at least one cooking element is settable either manually or automatically.

13. The cooking-learning support system according to claim 12, further comprising:
an input part, the controller being configured to receive a learning level-setting command for setting a learning level for at least one cooking element via the input part,
wherein, when the controller receives the learning level-setting command, the controller is operable to set the learning level for the at least one cooking element in accordance with the learning level-setting command.

14. The cooking-learning support system according to claim 12,
wherein, when a cooking record of the at least one cooking element becomes not smaller than a predetermined number of times, the controller is operable to raise the learning level for the at least one cooking element.

15. The cooking-learning support system according to claim 10,
wherein the storage is configured to store a plurality of recipes, each recipe identical to the at least one recipe, and
wherein the controller is operable to cause the information presenter to present a recipe of the plurality of recipes as a proposed recipe, the presented recipe including at least one cooking element having a cooking element-difficulty degree higher than the learning level by a predetermined degree.

16. The cooking-learning support system according to claim 15,
wherein the at least one cooking element comprises a plurality of cooking elements, and
wherein, in a case where the cooking elements in the plurality of recipes are identical, the cooking element-difficulty degree is common to the identical cooking elements.

17. The cooking-learning support system according to claim 15,
wherein the at least one cooking element comprises a plurality of cooking elements, and
wherein, in a case where the cooking elements in the plurality of recipes are identical, the learning level is common to the identical cooking elements.

18. The cooking-learning support system according to claim 1,
wherein the cooking-element reference level is a cooking element-participation degree that indicates an extent to which a second cook of a specific age can participate in implementation of the at least one cooking element and the at least one recipe, and
wherein the recipe reference level is a recipe-participation degree that indicates the extent to which the second cook of the specific age can participate in the implementation of the at least one cooking element and the at least one recipe.

19. The cooking-learning support system according to claim 18,
wherein the cooking element-participation degree indicates whether or not the implementation of the at least one cooking element is participable by the second cook, and
wherein the controller is operable to
calculate a ratio, to all of the at least one recipe, of the at least one cooking process corresponding to the at least one cooking element participable by the second cook, and
set the ratio as the recipe-participation degree corresponding to the at least one recipe.

20. The cooking-learning support system according to claim 18, further comprising:
an input part, the controller being configured to acquire a designated age via the input part,
wherein, when the controller acquires the designated age, the controller is operable to cause the information presenter to present, as a proposed recipe, a recipe having the recipe-participation degree for the designated age, the recipe-participation degree being not lower than a participation-degree threshold value.

21. The cooking-learning support system according to claim 20,
wherein the at least one recipe comprises a plurality of recipes, and
wherein the controller is operable to cause the information presenter to present the recipes each having the recipe-participation degree for the designated age in a descending order of the recipe-participation degree, the recipe-participation degree being not lower than a participation-degree threshold value.

22. The cooking-learning support system according to claim 18,
wherein the controller is operable to cause the information presenter to present, along with the at least one recipe and the recipe-participation degree, the at least one cooking process in the at least one recipe in a format emphasizing the at least one cooking process participable by the second cook.

23. The cooking-learning support system according to claim 18,
wherein the storage is configured to store either first support information for a first cook assisting the second cook or second support information for the second cook, both the first support information and the second support information corresponding to the at least one cooking element participable,
wherein the at least one cooking process comprises a plurality of cooking processes, and
wherein the controller is operable to cause the information presenter to present the at least one cooking process and either the first support information corresponding to at least one of the cooking processes or the second support information corresponding to at least one of the cooking processes.

24. The cooking-learning support system according to claim 23,
wherein the first support information is either explanation relating to participation of the second cook to the at least one cooking process or information relating to preparation for causing the second cook to participate in the at least one cooking process.

25. The cooking-learning support system according to claim 23,
wherein the second support information is information expressed by wording suitable for the second cook, the expressed information being on the at least one cooking process corresponding to the second support information.

26. The cooking-learning support system according to claim 23,
wherein the at least one cooking method comprises a plurality of cooking methods,
wherein the storage is configured to
store at least one of the cooking methods as a designated cooking method, and
store an alternative cooking method to the designated cooking method for each of the specific ages,
wherein, in the at least one cooking element including the designated cooking method, the controller is operable to cause the alternative cooking method to be presented instead of the designated cooking method, and
wherein either the first support information or the second support information is based on the alternative cooking method.

27. The cooking-learning support system according to claim 23,
wherein the controller is operable to cause the information presenter to present, along with the at least one cooking process and one of the first support information and the second support information, at least one of a character, a numeral, a symbol, a picture, a figure, a crest, a pattern, and a form, the at least one indicating an age corresponding to the one of the first support information and the second support information.

28. The cooking-learning support system according to claim 18,
wherein the at least one cooking element comprises a plurality of cooking elements, and the at least one recipe comprises a plurality of recipes, and
wherein, in a case where the cooking elements in the plurality of recipes are identical, the cooking element-participation degree is common to the identical cooking elements.

29. The cooking-learning support system according to claim 18,
wherein the storage is configured to store, as the cooking element-participation degree, a unique participation degree that indicates an extent to which a specific second cook can participate in the at least one cooking element.

30. The cooking-learning support system according to claim 29,
wherein a default value of the unique participation degree is the cooking element-participation degree for an age of the specific second cook.

31. The cooking-learning support system according to claim 29, further comprising:
an input part, the controller being configured to acquire designation of the specific second cook via the input part,
wherein, when the controller acquires the designation of the specific second cook, the controller is configured to cause the information presenter to present, as a proposed recipe, a recipe having the recipe-participation degree for the specific second cook, the recipe-participation degree being not lower than a participation-degree threshold value.

32. The cooking-learning support system according to claim 29, further comprising:
an input part, the controller is configured to receive a unique participation degree-setting command for setting a unique participation degree of at least one cooking element via the input part,
wherein, when the controller receives the unique participation degree-setting command, the controller is configured to set the unique participation degree of the at least one cooking element in accordance with the unique participation degree-setting command.

33. The cooking-learning support system according to claim 29,
wherein the controller is operable to cause the information presenter to present, along with the at least one cooking process and one of first support information and second support information, at least one of a character, a numeral, a symbol, a picture, a figure, a crest, a pattern, and a form, the at least one indicating either a name of the specific second cook or an age of the specific second cook.

34. The cooking-learning support system according to claim 29,
wherein the at least one cooking element comprises a plurality of cooking elements, and the at least one recipe comprises a plurality of recipes, and
wherein, in a case where the cooking elements in the plurality of recipes are identical, the unique participation degree is common to the identical cooking elements.

35. A cooking-learning support method, comprising the steps of:
reading at least one recipe including at least one cooking process and a cooking-element reference level of at least one cooking element corresponding to the at least one cooking process in the at least one recipe, the at least one cooking element being one of
at least one ingredient for cooking,
at least one cooking method for the at least one ingredient, and
a combination of the at least one ingredient and the at least one cooking method,
calculating a recipe reference level corresponding to the at least one recipe, based on the cooking-element reference level corresponding to the at least one cooking element in the at least one cooking process in the at least one recipe, and
presenting the calculated recipe reference level along with the at least one recipe.

36. The cooking-learning support method according to claim 35,
wherein the cooking-element reference level is at least one cooking element-difficulty degree for a first cook,
wherein the recipe reference level is a recipe-difficulty degree of the at least one recipe,
wherein, the at least one cooking element-difficulty degree comprises a plurality of cooking element-difficulty degrees, the at least one cooking element comprises a plurality of cooking elements, and the at least one cooking process comprises a plurality of cooking processes, the cooking element-difficulty degrees corresponding to the cooking elements in the cooking processes in the at least one recipe, and
wherein, in the step of calculating the recipe reference level,
one of
a sum total of the cooking element-difficulty degrees,
a maximum value of the cooking element-difficulty degrees, and
an average value of the cooking element-difficulty degrees is calculated, and
the one of
the sum total,
the maximum value, and
the average value is set as the recipe-difficulty degree corresponding to the at least one recipe.

37. The cooking-learning support method according to claim 35,
wherein the cooking-element reference level is a cooking element-participation degree that indicates an extent to which a second cook of a specific age can participate in implementation of the at least one cooking element and the at least one recipe,
wherein the recipe reference level is a recipe-participation degree that indicates the extent to which the second cook of the specific age can participate in the implementation of the at least one cooking element and the at least one recipe,
wherein, the cooking element-participation degree indicates whether or not the implementation of the at least one cooking element is participable by the second cook, and
wherein, in the step of calculating the recipe reference level, a ratio, to all of the at least one recipe, of the at least one cooking process corresponding to the at least one cooking element participable by the second cook is calculated, and the ratio is set as the recipe-participation degree corresponding to the at least one recipe.
